(19) United States
(12) Patent Application Publication
(10) Pub. No.: US 2026/0130824 A1
(43) Pub. Date: May 14, 2026

(54) SYSTEM FOR CONTROLLING OPERATION OF A BATHING UNIT SYSTEM INCLUDING A FIRST PROCESSING UNIT AND A SECOND PROCESSING UNIT

(71) Applicant: GECKO ALLIANCE GROUP INC., Québec (CA)

(72) Inventors: Dannik Gagnon, Trois-Rivières (CA); Guillaume Tremblay, Québec (CA); Kevin Bouchard, Québec (CA)

(21) Appl. No.: 19/189,514

(22) Filed: Apr. 25, 2025

Related U.S. Application Data
(60) Provisional application No. 63/718,098, filed on Nov. 8, 2024.
(60) Provisional application No. 63/757,722, filed on Feb. 12, 2025.

(51) Int. Cl. A61H 33/00; A47K 3/00; A47K 3/02

(52) U.S. Cl. CPC A61H 33/005; A47K 3/001; A47K 3/02; A61H 2033/0083

(57) ABSTRACT

A method is provided for controlling operation of a bathing unit system comprising a plurality of bathing unit components comprising a first set bathing unit component and a different second set bathing unit component. The method comprises: physically coupling the first set bathing unit component to a first processing unit located within a spa cabinet of the bathing unit system; physically coupling the second set bathing unit component to a second processing unit physically distinct from the first processing unit and also located within the spa cabinet; and physically coupling the second processing unit to the first processing unit. The first processing unit receives commands for controlling the second set bathing unit component from at least one control device; and relays the commands to the second set bathing unit component via the second processing unit. The second processing unit supplies power to the second set bathing unit component.

### CROSS-REFERENCE TO RELATED APPLICATIONS

This application claims the benefit of U.S. provisional application Nos. 63/718,098 filed Nov. 8, 2024 and 63/757,722 filed Feb. 12, 2025, the contents of which are incorporated by reference herein in their entirety.

### TECHNICAL FIELD

The present disclosure relates generally to operating bathing unit systems including but not limited to, a swimming pool, a spa, a hot tub, and other recreational and therapeutic units for holding water.

### BACKGROUND

A bathing unit system typically includes various bathing unit components such as: a receptacle holding water; one or more pumps to circulate water in a circulation system comprising a plurality of conduits, one or more temperature change modules (e.g., heaters to increase the water temperature and coolers to decrease the water temperature), a filter system to filter the water, sensors for sensing different metrics associated with the bathing unit system, the bathing unit components or a location where the bathing unit system is installed, lighting components, audio components and visual displays (and other components for creating an ambience), and a control system for activating and managing the various bathing unit components.

During a typical operation, a user can initiate a bathing session via at least one control device (e.g., a topside control panel) of the control system. A processing unit of the control system then operates the various bathing unit components, including the temperature change components, the pumps, the lighting components and/or other bathing unit components, all to create a desirable bathing session for a user. The processing unit may also supply power to the various bathing unit components to allow them to operate, such as for example supplying power to the pumps. Such processing units are typically located within a spa cabinet of the bathing unit system, e.g., underneath a spa skirt, for aesthetic reasons (e.g., as users typically prefer a bathing unit system which is an integral unit, with clean lines and no extraneous components). Additionally, due to the electrical components involved, these processing unit may need to be fully enclosed in order to satisfy safety requirements, particularly around the water environment of the bathing unit system.

Supplying power to various bathing unit components can cause the processing unit to produce a significant amount of heat. As such, it can be problematic for existing processing units to be coupled to, and to supply power to, too many bathing unit components at a same time due to heat produced by power supply lines and to the enclosed system of such processing units. However, as bathing unit systems become more advanced, it becomes more desirable to include additional bathing unit components (e.g., additional lighting components, additional pumps, additional air blowers, etc.) for more advanced control of the bathing unit system. Further, processing data also cause a microprocessor of the processing unit to produce heat. It can be problematic for existing processing units to perform complex processing of data (e.g., commands received from the control device and/or information received from different bathing unit components) due to the enclosed system of such processing units, particularly when these processing units also supply power at the same time. However, again as bathing unit systems become more advanced, it may be desirable or necessary to perform some local processing of information locally at the processing unit.

Further, being located within the spa cabinet can make it difficult for existing processing units to communicate wirelessly with some external control devices which are not directly wired to the processing units, such as a personal user device associated with a user or a remote control server associated with the bathing unit system. However, positioning the processing unit within the spa cabinet may maintain aesthetics of the bathing unit system as noted above (as unsightly cables are hidden). Positioning the processing unit within the spa cabinet may also provide a better ability to connect to various bathing unit components (which are often also located within the spa cabinet as well).

Against the background above, there is a need in the industry to provide an improved control system which allows coupling of additional bathing unit components, allows for more advanced/complex processing of data, and allows for improved communication with external control devices, while maintaining a suitable level of safety of the control system and aesthetics of the bathing unit system.

### SUMMARY

In one embodiment, there is provided a method for controlling operation of a bathing unit system comprising a plurality of bathing unit components, the plurality of bathing unit components comprising a first set bathing unit component and a second set bathing unit component different from the first set bathing unit component. The method comprises: physically coupling the first set bathing unit component to a first processing unit located within a spa cabinet of the bathing unit system; physically coupling the second set bathing unit component to a second processing unit physically distinct from the first processing unit and located within the spa cabinet; and physically coupling the second processing unit to the first processing unit. The first processing unit is configured to: receive second set commands for controlling the second set bathing unit component from at least one control device of the bathing unit system; and relay the second set commands to the second set bathing unit component via the second processing unit. The second processing unit is configured to supply power to the second set bathing unit component.

The first processing unit may be further configured to supply power to the first set bathing unit component.

The power supplied by the first processing unit to the first set bathing unit component may comprise power at a low-voltage level and the power supplied by the second processing unit to the second set bathing unit component may comprise power at a high-voltage level.

The low-voltage level may be at most 5V, at most 12V, or at most 50V.

The high-voltage level may be at least 120V, at least 230V or at least 240V.

The first processing unit may be further configured to: receive first set commands from the at least one control device for controlling the first set bathing unit component; and transmit the first set commands to directly to the first set bathing unit component.

The first processing unit may include at least one interface configured to wirelessly receive the second set commands and the first set commands from the at least one control device.

The at least one interface may comprise one or more of: a Bluetooth interface, a Wi-Fi interface, a cellular interface and another wireless network interface.

The second set bathing unit component may be one of a plurality of second set bathing unit components, each bathing unit component in the plurality of second set bathing unit components being physically coupled to the second processing unit. The first set bathing unit component may be one of a plurality of first set bathing unit components, each bathing unit component in the plurality of first set bathing unit components being physically coupled to the first processing unit.

The plurality of second set bathing unit components may comprise one or more of: a temperature change component, a pump, a lighting component, and an audio component.

The plurality of first set bathing unit components may comprise one or more of: a lighting component, an audio component, a visual display, a topside control panel, and a sensor.

The first processing unit may be further configured to: automatically derive identification information for specific bathing unit components within the plurality of first set bathing unit components; and automatically adjust how each bathing unit component in the plurality of first set bathing unit components is controlled at least in part based on the derived identification information.

The first processing unit may be further configured to: receive second set updates for updating the second set bathing unit component from the at least one control device; and relay the second set updates to the second set bathing unit component via the second processing unit.

The first processing unit may be further configured to: receive first set updates for updating the first set bathing unit component from the at least one control device; and transmit the first set updates directly to the first set bathing unit component.

The at least one control device may comprise one or more of: a topside control panel, a GUI displayed on a personal user device associated with a user, and a control server.

In another embodiment, there is provided a bathing unit system comprising: a plurality of bathing unit components comprising a first set bathing unit component and a second set bathing unit component different from the first set bathing unit component; a first processing unit located within a spa cabinet of the bathing unit system and physically coupled to the first set bathing unit component; and a second processing unit located within the spa cabinet, physically coupled to and physically distinct from the first processing unit, and physically coupled to the second set bathing unit component. The first processing unit is configured to: receive second set commands for controlling the second set bathing unit component from at least one control device of the bathing unit system; and relay the second set commands to the second set bathing unit component via the second processing unit. The second processing unit is configured to supply power to the second set bathing unit component.

The first processing unit may be further configured to supply power to the first set bathing unit component.

Power supplied by the first processing unit to the first set bathing unit component may comprise power at a low-voltage level and the power supplied by the second processing unit to the second set bathing unit component may comprise power at a high-voltage level.

The first processing unit may be further configured to: receive first set commands from the at least one control device for controlling the first set bathing unit component; and transmit the first set commands to directly to the first set bathing unit component.

The first processing unit may include at least one interface configured to wirelessly receive the second set commands and the first set commands from the at least one control device.

The second set bathing unit component may be part of a plurality of second set bathing unit components and the first set bathing unit component may be part of a plurality of first set bathing unit components. The bathing unit system may further comprise: the plurality of second set bathing unit components, each bathing unit component in the plurality of second set bathing unit components being physically coupled to the second processing unit; and the plurality of first set bathing unit components, each bathing unit component in the plurality of first set bathing unit components being physically coupled to the first processing unit.

The plurality of second set bathing unit components may comprise one or more of: a temperature change component, a pump, a lighting component, and an audio component.

The plurality of first set bathing unit components may comprise one or more of: a lighting component, an audio component, a visual display, a topside control panel, and a sensor.

The first processing unit may be further configured to: receive second set updates for updating the second set bathing unit component from the at least one control device; and relay the second set updates to the second set bathing unit component via the second processing unit.

The first processing unit may be further configured to: receive first set updates for updating the first set bathing unit component from the at least one control device; and transmit the first set updates directly to the first set bathing unit component.

In another embodiment, there is provided a method for controlling operation of a bathing unit system comprising a specific bathing unit component having at least one high-voltage element and at least one low-voltage element. The method comprises: physically coupling a communication interface of the specific bathing unit component to a first processing unit located within a spa cabinet of the bathing unit system, the communication interface being coupled to the at least one low-voltage element of the specific bathing unit component; physically coupling a power interface of the specific bathing unit component to a second processing unit located within the spa cabinet, the power interface being coupled to the at least one high-voltage element of the specific bathing unit component; and physically coupling the second processing unit to the first processing unit. The first processing unit is configured to directly exchange communication signals with the at least one low-voltage element of the specific bathing unit component via the communication interface. The second processing unit is configured to supply power to the at least one high-voltage element of the specific bathing unit component via the power interface.

The specific bathing unit component may be one or more of: a temperature change component, a pump, a lighting component, an audio component, a visual display, and a sensor.

The first processing unit may be further configured to supply power to the at least one low-voltage element of the specific bathing unit component.

The power supplied by the first processing unit to the at least one low-voltage element of the specific bathing unit component may comprise power at a low-voltage level and the power supplied by the second processing unit to the at least one high-voltage element of the specific bathing unit component may comprise power at a high-voltage level. The low-voltage level may be at most 50V and the high-voltage level is at least 120V.

The method may further comprise physically coupling at least one second set bathing unit component to the second processing unit. The first processing unit may be further configured to: receive commands for controlling the at least one second set bathing unit component from at least one control device of the bathing unit system; and relay the commands to the at least one second set bathing unit component via the second processing unit.

In another embodiment, there is provided a bathing unit system comprising a specific bathing unit component having at least one high-voltage element and at least one low-voltage element. The specific bathing unit component has: a communication interface coupled to the at least one low-voltage element of the specific bathing unit component; and a power interface coupled to the at least one high-voltage element of the specific bathing unit component. The bathing unit system further comprises: a first processing unit located within a spa cabinet of the bathing unit system and physically coupled to the communication interface of the specific bathing unit component; and a second processing unit located within the spa cabinet, physically coupled to and physically distinct from the first processing unit, and physically coupled to the power interface of the specific bathing unit component. The first processing unit is configured to directly exchange communication signals with the at least one low-voltage element of the specific bathing unit component via the communication interface. The second processing unit is configured to supply power to the at least one high-voltage element of the specific bathing unit component via the power interface.

Advantageously, the first processing unit is configured to process signals and information and to supply low-voltage control and power signals to components in the bathing unit system while the second processing unit is configured to process low-voltage control signals from the first processing unit and to supply high-voltage power signals to components in

the bathing unit system. By separating low-voltage and high-voltage power supply functions and processing capability, a more modular and scalable bathing control system can be obtained.

The first processing unit and the second processing unit may each be embodied in a respective physical structure or box having physical input and output ports and/or wireless antennas for providing interconnectivity of control signals and/or power supply.

All features of embodiments which are described in this disclosure and are not mutually exclusive can be combined with one another. Elements of one embodiment can be utilized in the other embodiments without further mention. Other aspects and features of the present invention will become apparent to those ordinarily skilled in the art upon review of the following description of specific embodiments in conjunction with the accompanying drawings.

### BRIEF DESCRIPTION OF THE DRAWINGS

A detailed description of the embodiments of the present invention is provided herein below, by way of example only, with reference to the accompanying drawings, in which:

FIG. 1 is a schematic diagram of a bathing unit system in accordance with one embodiment;

FIG. 2 is a schematic representation of a receptacle and spa cabinet of the bathing unit system of FIG. 1, with a first processing unit and a second processor unit of a control system located within the spa cabinet and a first network interface of the first processing unit located proximate a corner of a receptacle shell of the receptacle in accordance with one embodiment;

FIG. 3 is a schematic representation of the first processing unit of the control system shown in FIG. 2 in accordance with one embodiment;

FIG. 4 is a schematic representation of the second processing unit of the control system shown in FIG. 2 in accordance with one embodiment;

FIG. 5 is a schematic representation of different wired connections as between the first processing unit, the second processing unit, and various bathing unit components of the bathing unit system of FIG. 1; and

FIG. 6 is a flowchart of a process for coupling the first processing unit, the second processing unit and various bathing unit components of the bathing unit system of FIG. 1.

In the drawings, the embodiments of the invention are illustrated by way of examples. It is to be expressly understood that the description and drawings are only for the purpose of illustration and are an aid for understanding. They are not intended to be a definition of the limits of the invention.

### DETAILED DESCRIPTION

The description below is directed to specific implementations and uses of embodiments of the invention in context of a bathing unit system. The phrase “bathing unit system” as used herein include without limitation spas/swim-spas, whirlpools, hot tubs, bath tubs, therapeutic baths and swimming pools and any other type of unit having a receptacle for holding water. Moreover, while specific embodiments have been described for use in the context of bathing unit systems, one skilled in the art will appreciate that, in view of the present description, alterative embodiments may be configured for use in any system including a body of water which can be operated for enjoyment, where more than one processing unit may be coupled to, supply power to, and used to operate, various components of the system.

For the purpose of this disclosure, the expression “first set of the bathing unit components” (also referred to as “first set bathing unit components” or “low-voltage bathing unit components”) is intended to designate bathing unit components configured for operating using low-voltage power or bathing unit components having low-voltage elements configured for operating using low-voltage power. The expression “second set of bathing unit components” (also referred to as “second set bathing unit components” or “high-voltage bathing unit components”) is intended to designate bathing unit components which require high-voltage power to operate, or bathing unit components having high-voltage elements which require high-voltage power to operate. While the specific values may vary between implementations, as generally used herein, “low-voltage” (also referred to as “low power”) may be at most 50V and “high-voltage” (also referred to as “high power”) may be at least 120V. For example, low-voltage power may be at most 50V, at most 30V, at most 12V, or at most 5V. More specifically, a low power or low-voltage drawn/required by a first set bathing unit component may be 50V, 30V, 12V, 5V or any other low power value in dependence on the nature of the particular bathing unit component. As another example, high-voltage power may be at least 120V, be at least 180V, be at least 200V, be at least 220V, be at least 230V or be at least 240V. More specifically, a high power or high-voltage drawn/required by a second set bathing unit component may be 120V, 180V, 200V, 220V, 230V, 240V or any other high power value in dependence on the nature of the particular bathing unit component.

Further, for the purpose of this disclosure, the expression “low-speed communication” is intended to designate communication over lower-speed connections, such as for example, but without being limited to, USB 1.0 connections, RS-485 connections, RS-232 connections, RS-422 connections, Inter-Integrated Circuit (I2C) connections, and basic Ethernet connections. In contrast, the expression “high-speed communication” is intended to designate communication over higher speed connections, such as for example, but without being limited to, USB 2.0 connections, USB 3.0 connections, fast Ethernet connections, and Gigabit Ethernet connections. While the specific values may vary between implementations, as generally used herein, “low-speed” may be at most 150 Mbps while “high-speed” may be at least 200 Mbps. For example, the low-speed communication signals required by a particular bathing unit component may be around 50 Kbps, 100 Kbps, or any other low-speed value in dependence on the nature of the particular bathing unit component. In contrast, high-speed communication signals required by a particular bathing unit component may be around 480 Mbps, 5 Gbps, or 10 Gbps, or any other high-speed value in dependence on the nature of the particular bathing unit component.

### Bathing Unit System 100

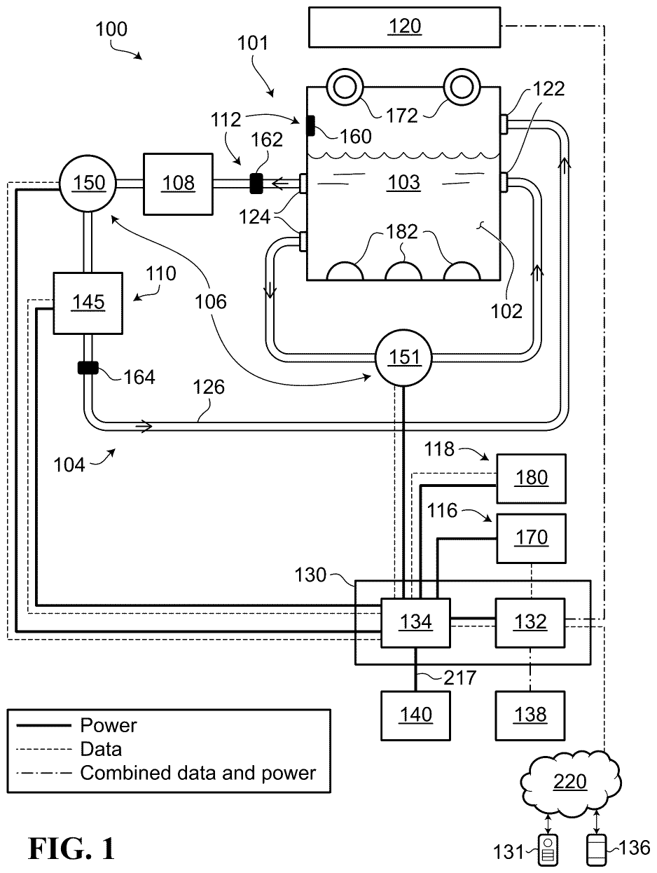

Referring to FIG. 1, a bathing unit system 100 includes a receptacle 102 for holding water 103 is installed at a field location 101. The receptacle 102 includes a plurality of water inlets 122 (which will typically be connected to respective jets) and a plurality of water outlets 124. The bathing unit system 100 further includes a circulation system 104 including a plurality of conduits 126 for removing water from, and returning water to, the receptacle 102 through the water inlets 122 and the water outlets 124.

The bathing unit system 100 includes a set of bathing unit components. The set of bathing unit components includes at least one filter 108, one or more pumps 106, at least one temperature change component 110, one or more sensors 112 (e.g., temperature sensors, water quality monitoring sensor/system, etc.), at least one audio component 116, at least one lighting component 118, at least one visual display 120, etc. In other embodiments, the bathing unit system 100 may include additional, fewer or alternative bathing unit components, such as at least one air blower for generating air bubbles in the receptacle 102, at least one diverter component for diverting water towards one particular water inlet 122, at least one sanitizer component (e.g., UV tube, ozonator, chemical dispenser, etc.) for sanitizing the water 103, etc.

The bathing unit system 100 may also include a control system 130 in communication with the above-mentioned bathing unit components. As will be described below, the control system 130 includes a first processing unit 132 and a second processing unit 134. The first processing unit 132 and the second processing unit 134 may each be embodied in a respective physical structure or body having physical input and output ports/interfaces and/or wireless antennas for providing interconnectivity of communication signals and/or power supply from a power source 140.

As will be described below, the first processing unit 132 is configured to (A) process commands and software/firmware updates received from a control device of the bathing unit system (e.g., a topside control panel 138, a user device 136, alone or in combination with a control server 131), (B) directly communicate these commands and updates to certain bathing unit components (e.g., the first set bathing unit components) which are directly physically coupled to the first processing unit 132, using the high-speed and/or the low-speed communication signals, (C) relay these commands and updates to certain bathing unit components (e.g., the second set bathing unit components) which are instead directly physically coupled to the second processing unit 134, primarily using the low-speed communication signals, and (D) supply/distribute low-voltage power to certain bathing unit components in the bathing unit system 100 (e.g., the first set bathing unit components or the low-voltage bathing unit components). In contrast, the second processing unit 134 is configured to (A) relay commands and updates received from the first processing unit 132 to certain bathing unit components (e.g., the second set bathing unit components) which are directly physically coupled to the second processing unit 134, primarily using the low-speed communication signals, and (B) supply/distribute high-voltage power to certain components in the bathing unit system 100 (e.g., the second set bathing unit components or the high-voltage bathing unit components, as well as the first processing unit 132). By separating low-voltage power and high-voltage power supply/distribution as between the first and second processing units 132 and 134, the control system 130 may provide the control system 130 with increased scalability (e.g., possible to connected additional bathing unit components to the control system 130 without overheating a particular processing unit 132 or 134) and may also have increased modularity (e.g., possible to replace one, but not both, of the first or second processing units 132 or 134 at a time). Further, by locating a majority of the processing functionality in the first processing unit 132 and a majority of the power supply functionality in the second processing unit 134, the control system 130 also separates two heat-producing sources, which may reduce the likelihood of overheating a particular processing unit 132 or 134.

The various bathing unit components may require different levels of power to operate and to implement different desired settings for the bathing unit system 100. Some bathing unit components may be considered high-voltage bathing unit components (e.g., second set bathing unit components) and require power to be supplied at a high-voltage or a high-power level. Other bathing unit components may be low-voltage bathing unit components (e.g., a first set bathing unit components) and are operable using power supplied at a low-voltage power or at a low-power level. As described above, “low-voltage” (also referred to as “low power”) may be at most 50V and “high-voltage” (also referred to as “high power”) may be at least 120V. As a more specific example, a low power or low-voltage power required by a particular bathing unit component may be 50V, 30V, 12V, 5V or any other low power value in dependence on the nature of the particular bathing unit component. As another more specific example, a high-power or high-voltage power required by a particular bathing unit component may be 120V, 180V, 200V, 220V, 230V, 240V or any other high-power value in dependence on the nature of the particular bathing unit component. As described below, high-voltage bathing unit components (e.g., again, the second set bathing unit components) may be physically coupled to, and received power from, the second processing unit 134 and the low-voltage bathing unit components (e.g., again, the first set bathing unit components) may be physically coupled to, and received power from, the first processing unit 132.

In some embodiments, some of the bathing unit components include different elements which require different types of power supply to operate. For example, a variable speed pump 150 (e.g., one of the one or more pumps 106) may include high-voltage elements (e.g., a main motor) and low-voltage elements (e.g., one or more pump processors for varying a speed of the main motor and/or one or more pump sensors, such as sensors for sensing water flow through the pump 150, temperature of the water through the pump 150, water volume through the pump 150). Generally, when a bathing unit component includes both low-voltage and high-voltage elements, the low-voltage elements are often periphery communication elements, processing elements, or sensing elements, whereas the high-voltage elements are typically “active elements” which perform the major function of the bathing unit component (e.g., a motor for a pump 106, a heating or cooling element for a temperature change component 110).

Additionally, the various bathing unit components may communicate with the control system 130 during operation of the bathing unit system 100. Some bathing unit components may require high-speed communication signals to communicate large volumes of data or complex data (e.g., audio data, video data, image data) for performance and/or fidelity. Other bathing unit components may instead only require low-speed communication signals as they may primarily communicate simple data (e.g., numerical values). As described above, while specific values may vary, “low-speed” communication may be at most 150 Mbps, while “high-speed” communication may be at least 200 Mbps. For example, the low-speed communication signals required by a particular bathing unit component may be around 50 Kbps, 100 Kbps, or any other low-speed value in dependence on the nature of the particular bathing unit component. In contrast, high-speed communication signals required by a particular bathing unit component may be around 480 Mbps, 5Gbps, or 10 Gbps, or any other high-speed value in dependence on the nature of the particular bathing unit component. As will be described below, the high-speed communication signals may be enabled by a physical (e.g., a wired connection) connection between a particular bathing unit component and the first processing unit 132, whereas the low-speed communication signals may be enabled by a physical connection between a particular bathing unit component and the second processing unit 134 and also a physical connection between a particular bathing unit component and the first processing unit 132.

### Bathing Unit Components

Different bathing unit components of the bathing unit system 100 will now be described below.

### Filter 108

Referring to FIG. 1, the filter 108 may generally function to filter 108 solids and other debris from the water flowing through the circulation system 104. In the embodiment

shown, the bathing unit system 100 may include a single filter 108 positioned in the circulation system 104 before the other bathing unit components. In other embodiments, the bathing unit system 100 may include more than one filter 108, and may, e.g., include a large main filter and one or more smaller filters associated with the with the pump 106 and/or the temperature change component 110.

The filter 108 may be a controlled filter which receives communication signals from the control system 130 during operation of the bathing unit system 100, and may receive communication signals to be turned on (or caused to acquire an activated stated), to operate in a particular mode (e.g., filtration mode, flow-through mode), to be turned off (or caused to acquire a deactivated state), etc. The communication signals received by the filter 108 may comprise the low-speed communication signals. The low-speed communication signals received by the filter 108 may have been received from the second processing unit 134 (which may have been originally generated by the first processing unit 132), or may have been received directly from the first processing unit 132 without the second processing unit 134 functioning as an intermediary. However, those skilled in the art will recognize that, in other embodiments, the communication signals received by the filter 108 may also comprise the high-speed communication signals received from the first processing unit 132.

In some implementations, the filter 108 may be a powered filter which draws power from the power source 140 during operation of the bathing unit system 100. In such implementations, the filter 108 may comprise a low-voltage bathing unit component (e.g., a first set bathing unit component) which draws low-voltage power from the power source 140 (e.g., 50V, 30V, 12V or 5V) via the first processing unit 132 or optionally directly from the second processing unit 134. However, in some embodiments, the powered filter 108 may alternatively be a high-voltage bathing unit component (and/or include high-voltage elements, e.g. a second set bathing unit component) which draws high-voltage power from the power source 140 (e.g., 120V or 240V) via the second processing unit 134.

### Pump 106

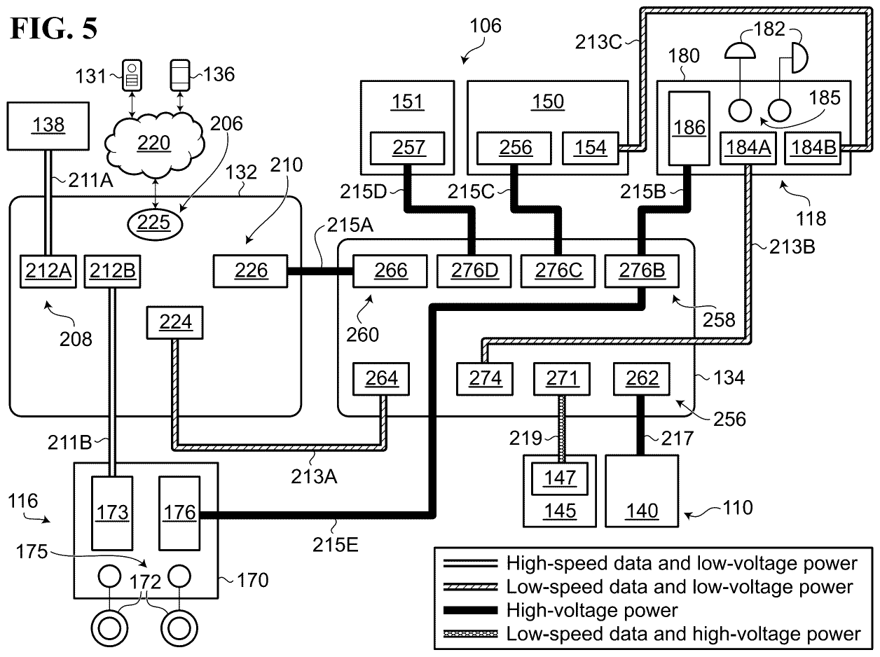

The pump 106 may generally function to circulate the water from the receptacle 102 through the water outlets 124, through the circulation system 104 and back into the receptacle 102 through the water inlets 122. The bathing unit system 100 may include a plurality of different pumps (e.g., a circulation pump versus a jet pump), although only the variable speed pump 150 and a standard pump 151 are shown in FIGS. 1 and 5.

The variable speed pump 150 and the standard pump 151 may both be powered pumps including respective main motors (not shown) which draw energy from the power source 140. The variable speed pump 150 may be operated in, for example, a low-speed mode where the main motor of the variable speed pump 150 draws a low amount of power from the power source to operate at a corresponding low-speed, a standard-speed mode drawing a standard amount of power to operate at a standard speed, and a high-speed mode drawing a high amount of power to operate at a high-speed. Alternatively, the variable speed pump 150 may be percentage modulated and the main motor may operate anywhere between 0% and 100% of a maximum speed, and may correspondingly draw anywhere between 0% and 100% of a maximum amount of power from the power source 140. In contrast, the standard pump 151 may operate in a single speed only, and may only have an on mode (or activated mode) and an off mode (or deactivated mode). One skilled in the art will appreciate that different embodiments of the bathing unit system 100 may include additional or alternative types of pumps.

In the embodiment shown in FIGS. 1 and 5, the variable speed pump 150 and the standard pump 151 are both high-voltage bathing unit components (e.g., second set bathing unit components) or both include high-voltage elements (i.e., active elements such as respective main motors) which draw high-voltage power from the power source 140 via the second processing unit 134, or draw a percentage (e.g., between 0% and 100%) of the high-voltage power based on a current operational mode of the pump 150 and 151 (e.g., low mode, standard mode, high mode, on mode, or off mode). Specifically referring to FIG. 5, the variable speed pump 150 includes a high-voltage power relay 256 as a power interface for receiving the high-voltage power, and the standard pump 151 includes a high-voltage power relay 257 as a power interface for receiving the high-voltage power. The high-voltage power relays 256 and 257 are operable to receive respective wired power connections 215C and 215D which couple the pumps 150 and 151 to the second processing unit 134 as described below. In other embodiments, the pumps 150 and 151 may be directly physically coupled to the power source 140 (e.g., without the second processing unit 134 as an intermediary).

In some embodiments (not shown), the variable speed pump 150 may also include low-voltage elements (e.g., communication or processing elements such as the one or more pump processors for varying or controlling a speed of the main pump or the one or more pump sensors) which draws the low-voltage power via the first processing unit 132 or optionally directly from the second processing unit 134. In such embodiments, the variable speed pump 150 may include a low-voltage power port (not shown) as a power interface for receiving the low-voltage power from either the first processing unit 132 or from the second processing unit 134. Alternatively, the variable speed pump 150 may utilize low-speed data ports (not shown) as combined low-speed data/low-voltage power ports, and may receive the low-voltage power from the first processing unit 132 (e.g., in embodiments where the first processing unit 132 functions as a master processing unit of the bathing unit system 100 that generates commands for controlling the variable speed pump 150) or from the second processing unit 134 (e.g., in embodiments where the second processing unit 134 functions as the master processing unit). As a further alternative, the variable speed pump 150 may also include a combined high-speed data/low-voltage power port (not shown) as a combined power and communication interface for receiving the low-voltage power and for receiving the high-speed communication signals, both from the first processing unit 132. For example, the combined high-speed data/low-voltage power port may be operable to receive a wired data/power connection 211 which couple the variable speed pump 150 to the first processing unit 132 as described below.

The variable speed pump 150 may operate in the different modes based on communication signals received from the control system 130 during operation of the bathing unit system 100. For example, if the control system 130 receives user input indicating that that the user would like to use the bathing unit system 100 in a “deep massage” mode, the control system 130 may transmit communication signals to the variable speed pump 150 to operate at the high mode or 100% mode to implement the deep massage mode. In the embodiment shown in FIGS. 1 and 5, such communication signals received by the variable speed pump 150 may comprises low-speed communication signals received from the second processing unit 134 (and which may have been originally generated by the first processing unit 132 in response to the user input as described below) or may comprise low-speed communication signals received directly from the first processing unit 132 (e.g., without the second processing unit 134 acting as an intermediary). Specifically referring to FIG. 5, the variable speed pump 150 includes a low-speed data port 154 as a communication interface for receiving the low-speed communication signals. The low-speed data port 154 is operable to receive a wired data connection 213C which eventually (e.g., in a serial daisy-chain configuration) couples the variable speed pump 150 to the first processing until 132 (e.g., via the second processing unit 134). However, in other embodiments, the communication signals received by the variable speed pump 150 may also comprise high-speed communication signals received directly from the first processing unit 132, such as via the combined high-speed data/low-voltage power port (not shown) described above.

In contrast, the standard pump 151 may not require any communication signals from the control system 130 to operate in the different modes, and may not include any communication interfaces or data ports separate from the high-voltage power relay 257. Rather, the standard pump 151 may simply turn on and off based on whether the high-voltage power is received over the high-voltage connection 215D from the second processing unit 134. As described below, a local processor 250 of the second processing unit 134 may control a second component interface 258 of the second processing unit 134 in order to supply, or to not supply, the high-voltage power to the standard pump 151.

### Temperature Change Component 110

The temperature change component 110 may generally function to change a temperature of the water flowing through the circulation system 104 and within the receptacle 102 by inputting thermal energy therein or by removing thermal energy therefrom. The temperature change component 110 may be a primary heater 145 generally configured to heat the water 103. In other embodiments, the bathing unit system 100 may include additional or alternative temperature change components, including a primary cooler generally configured to cool the water 103 and a combined auxiliary heater/cooler generally configured to assist the heater 145 and/or the primary cooler as applicable.

The heater 145 may be an electrical heater including a heating element which draws power from the power source 140. The heater 145 may be operable in, for example, a low mode where the heating element draws a low amount of power from the power source 140 to generate a correspondingly low amount of thermal energy, a standard mode drawing a standard amount of power to generate a corresponding standard amount of thermal energy, and a high mode drawing a high amount of power to generate a correspondingly high amount of thermal energy. Alternatively, the heater 145 may be percentage modulated, and the heating element may operate anywhere between 0% and 100% of a maximum heating capacity, and may draw anywhere between 0% and 100% of a maximum amount of power from the power source 140. One skilled in the art will appreciate that different embodiments of the bathing unit system 100 may include additional or alternative types of heaters.

In the embodiment shown in FIGS. 1 and 5, the heater 145 comprises a high-voltage bathing unit component (e.g., a second set bathing unit component) or includes high-voltage elements (e.g., active elements such as the heating element) which draw high-voltage power from the power source 140 via the second processing unit 134 or draw a percentage (e.g., between 0% and 100%) of the high-voltage power based on a current operational mode of the heater 145 (e.g., the low mode, the standard mode, or the high mode). However, those skilled in the art will recognize that, in some embodiments, the heater 145 will also include low-voltage elements (e.g., communication or processing elements such as one or more heater processors for controlling or varying or communicating an output of the heating element, or sensing elements such as one or more heater sensors for sensing water flow through the heater 145, temperature of the water 103 before entering or after exiting the heater 145, etc.) which may draw the low-voltage power instead via the first processing unit 132 or optionally directly from the second processing unit 134.

The heater 145 may operate in the different modes based on communication signals received from the control system 130 during operation of the bathing unit system 100. For example, if the control system 130 receives user input indicating that that the user would like to use the bathing unit system 100 very quickly at a high desired water temperature (e.g., 100° F. in 30 minutes) and a current water temperature is significantly below the desired water temperature (e.g., 70° F.), the control system 130 may transmit communication signals to the heater 145 directing the heater 145 to operate in the high mode, or at 100% power. In contrast, if the control system 130 receives user input indicating that the user has scheduled use of the bathing unit system 100 at the high desired water temperature but in four hours, the control system 130 may instead transmit communication signals to the heater 145 to operate in the standard mode to save energy costs. In the embodiment shown in FIGS. 1 and 5, such communication signals received by the heater 145 comprises low-speed communication signals. The low-speed communication signals received by the heater 145 may have been received from the second processing unit 134 (and which may have been originally generated by the first processing unit 132), or may have been received directly from the first processing unit 132 (e.g., without the second processing unit 134 acting as an intermediary). However, those skilled in the art will recognize that, in other embodiments, the communication signals received by the heater 145 may also comprise high-speed communication signals received from the first processing unit 132 as described below.

Specifically referring to FIG. 5, the heater 145 includes a combined low-speed data/high-voltage power interface 147 as a combined power and communication interface for receiving both the high-voltage power from the power source 140 and the low-speed communication signals from the second processing unit 134. The combined low-speed data/high-voltage power interface 147 is operable to receive an integrated power/data interface 219 to couple the heater 145 to the second processing unit 134. In this regard, the combined low-speed data/high-voltage power interface 147 of the heater 145, a corresponding combined high-voltage power/low-speed data interface 271 of the second processing unit 134 and the integrated power/data interface 219 may allow the heater 145 to be formed as an integral unit with the second processing unit 134. For example, the combined low-speed data/high-voltage power interface 147 may be at least one pin configured to fit into at least one recess formed by the corresponding combined high-voltage power/low-speed data interface 271.

### Sensor(s) 112

Referring to FIG. 1, the one or more sensors 112 may generally function to sense different aspects of the bathing unit system 100. The one or more sensors 112 may include a receptacle temperature sensor configured to measure a temperature of the water 103 within the receptacle 102, an inline temperature sensor configured to sense a temperature of the water 103 before or after it passes through the at least one temperature change component 110, an ambient temperature sensor configured to sense an ambient temperature of the environment at the field location 101 around the bathing unit system 100, etc. In other embodiments, the one or more sensors 112 may include additional and/or alternative sensors 112 which sense attributes of the water 103 within the bathing unit system 100 different from water temperature, and may include, e.g., a depth sensor, a flow sensor, a pH sensor, an ORP sensor, a turbidity sensor, etc. In yet other embodiments, the one or more sensors 112 may further include additional and/or alternative sensors which sense environmental factors other than ambient temperature, and may include e.g., a humidity sensor, a light sensor, a windspeed sensor, precipitation sensor, etc. Those skilled in the art will recognize that different embodiments of the bathing unit system 100 may include a wide variety of different types of sensors.

In the embodiment shown in FIG. 1, the one or more sensors 112 includes a receptacle temperature sensor 160 positioned in the receptacle 102 for sensing the temperature of the water 103 within the receptacle 102, a pH sensor 162 positioned in the circulation system 104 for sensing pH of the water 103 flowing through the circulation system 104 and a camera sensor 164 positioned in the circulation system 104 for capturing images of the water 103 flowing through the circulation system 104.

The sensors 160, 162 and 164 may comprise low-voltage bathing unit components (e.g., first set bathing unit components) or include low-voltage elements, which draw the low-voltage power via the first processing unit 132 or optionally directly from the second processing unit 134. However, those skilled in the art will appreciate that, in other embodiments, sensors 112 of the bathing unit system 100 may be high-voltage bathing unit components or include high-voltage elements.

The receptacle temperature sensor 160, the pH sensor 162 and the camera sensor 164 may operate based on communication signals from the control system 130. For example, each of the sensors 160, 162 and 164 may be receptive to an activation signal from the control system 130 to turn on and sense/capture a corresponding metric, such as a temperature value by the temperature sensor 160, a pH value by the pH sensor 162 and an image by the camera sensor 164. The activation signal may be transmitted by the control system 130 at fixed pre-set intervals (e.g., every second, every five seconds, every hour, every 12 hours, every 24 hours, etc.) and/or may be transmitted in response to user input requesting the sense/capture of the corresponding metric. Each of the sensors 160, 162 and 164 may also be configured to transmit sensed/captured corresponding metric back to the control system 130 for processing and/or storage.

The temperature sensor 160 and the pH sensor 162 may only require the low-speed communication signals to receive the commands and to transmit their captured metrics. In this regard, the temperature values generated by the temperature sensor 160 and the pH values generated by the pH sensor 162 may comprise a small amount of data which can be easily transmitted at a lower speed of the low-speed communication signals. Further, as described above, the temperature sensor 160 and the pH sensor 162 may require the low-voltage power to operate. Accordingly, even though the temperature sensor 160 and the pH sensors 162 do not require the high-speed communication signals of the first processing unit 132, it may be more schematically efficient (e.g., reducing a total number of wired connections 211, 213, and 215) to couple the temperature sensors 160 and the pH sensors 162 directly to the first processing unit 132 and to allow both the high-speed communication signals and the low-voltage power to be transmitted over a single wired data/power connection 211 as described below. Alternatively, the temperature sensors 160 and the pH sensors 162 may be directly and physically coupled to the second processing unit 134, but may transmit low-speed communication signals with, and receive low-voltage power from, the first processing unit 132 via the serial daisy-chain configuration in embodiments where the first processing unit 132 functions as the master processing unit.

In contrast, the camera sensor 164 may require the high-speed communication signals to transmit its captured metrics. In this regard, images generated by the camera sensor 164 may comprise a larger amount of data which needs to be transmitted at a higher speed of the high-speed communication signals for performance and/or fidelity. In such embodiments, the camera sensor 164 may be physically coupled to the first processing unit 132 and the images captured by the camera sensor 164 may be transmitted via the high-speed communication signals directly to the first processing unit 132. In some embodiments, the camera sensor 164 may be capable of operating using the low-voltage power. In such embodiments, the camera sensor 164 may only be coupled to the first processing unit 132 over a single wired data/power connection 211 and both the high-speed communication signals and the low-voltage power may be transmitted over this single wired data/power connection 211 as described below. In other embodiments, the camera sensor 164 may instead require the high-voltage power to operate. In such embodiments, the camera sensor 164 may include both a wired data connection 211 to the first processing unit 132 (to transmit the high-speed communication signals) and a wired power connection 215 to the second processing unit 134 (to transmit the high-voltage power).

Those skilled in the art will recognize that other sensors 112 may be physically coupled with, and initially communicate with, either the first processing unit 132 or the second processing unit 134 based on the type of metrics captured by the sensor 112 and based on the level of voltage required by the sensor 112. Sensors 112 which capture metrics associated with a large amount of data (e.g., images, audio, video etc.) may be physically coupled with the first processing unit 132 and may communicate via the high-speed communication signals. In contrast, sensors 112 which capture metric associated with a small amount of data (e.g., numerical values) may instead be physically coupled with either the first processing unit 132 or

the second processing unit 134 and may communicate via the low-speed communication signals. Sensors 112 which only require the low-voltage power may be physically coupled with either the first processing unit 132 or the second processing unit 134. In contrast, sensors 112 which require the high high-voltage power may instead be physically coupled with the second processing unit 134 (potentially in combination with the first processing unit 132 based on the type of metrics captured by the sensor 112).

Those skilled in the art will also recognize that various sensors 112 may be additional bathing unit components which are desirable to couple to the control system 130 as the bathing unit system 100 becomes more advanced. For example, the manufacturer of the bathing unit system 100 may wish to include additional cameras and microphones in the bathing unit system 100 to improve user experience, to allow users to provide user input via voice commands, to allow users to provide user input via gestures, etc. As sensors 112 are typically low-voltage bathing unit components (e.g., first set bathing unit components) capable of operating using the low-voltage power, but may require high-speed communication signals as the sensors 112 become more complex, utilizing the first processing unit 132 which is precisely capable of providing low-voltage power and high-speed communication signals via a single wired data/power connection 211 can allow to add more sensors 112 then was possible utilizing existing processing units.

### Lighting Component 118

Referring to FIGS. 1 and 5, the lighting component 118 may include a lighting driver 180 and a plurality of light ports 185 for connecting the lighting driver 180 to one or more lights 182 located in or around the receptacle 102. The various elements of the lighting component 118 may generally function to light the water 103 within the receptacle 102 or the field location 101 around the bathing unit system 100 for ambience.

The lighting driver 180 may be powered by the power source 140 (and may relay this power to the one or more lights 182) and may be responsive to communication signals to cause the one or more lights 182 to operate in different operational settings. For example, the one or more lights 182 may be turned on and off, may have different color settings, may have different brightness settings, and/or may be controlled through different sequences of color and brightness settings over different periods of time (e.g., an ambience sequence). In the embodiment shown in FIGS. 1 and 5, the lighting driver 180 comprises a high-voltage bathing unit component (e.g., a second set bathing unit component) and includes high-voltage elements (i.e., active elements such as the one or more lights 182) which draw high-voltage power from the power source 140 via the second processing unit 134. Specifically referring to FIG. 5, the lighting driver 180 includes a high-voltage power interface 186 for receiving the high-voltage power. The high-voltage power interface 186 is operable to receive a wired power connection 215B which physically couple the lighting driver 180 to the second processing unit 134 as described below. The lighting driver 180 may then relay the received high-voltage power to the one or more lights 182 via the plurality of lighting ports 185. In some embodiments, the lighting driver 180 may also be configured to convert the received high-voltage power into low-voltage power before distributing the converted low-voltage power to the one or more lights 182 via the plurality of lighting ports 185. Converting the received high-voltage power into the low-voltage power may allow the lighting driver 180 to power a larger number of lights.

In some embodiments (not shown), the lighting driver 180 may also include low-voltage elements (e.g., communication or processing elements such as one or more lighting processors for varying or controlling a pattern or a colour of the one or more lights 182) which draws the low-voltage power via the first processing unit 132 or optionally directly from the second processing unit 134. In such embodiments, the lighting driver 180 may include a low-voltage power port (not shown) as a power interface for receiving the low-voltage power from either the first processing unit 132 or from the second processing unit 134. Alternatively, the lighting driver 180 may utilize the low-speed data ports 184A and 184B described below as combined low-speed data/low-voltage power ports, and may receive the low-voltage power from the first processing unit 132 (e.g., in embodiments where the first processing unit 132 functions as a master processing unit that generates commands for controlling the one or more lights 182) or from the second processing unit 134 (e.g., in embodiments where the second processing unit 134 functions as the master processing unit). As a further alternative, the lighting driver 180 may also include a combined high-speed data/low-voltage power port (not shown) as a combined power and communication interface for receiving the low-voltage power and for receiving the high-speed communication signals, both from the first processing unit 132. For example, the combined high-speed data/low-voltage power port may be operable to receive a wired data/power connection 211 which couple the lighting driver 180 to the first processing unit 132 as described below. In other embodiments, individual lights 182 may comprise low-voltage bathing unit components or low-voltage elements which draw the low-voltage power via the first processing unit 132 or optionally directly from the second processing unit 134.

As described above, the lighting driver 180 may cause the one or more lights 182 to operate in the different operational settings based on communication signals received from the control system 130. For example, if the control system 130 of these user input indicating that the user would like a “romantic” ambience, the control system 130 may transmit communication signals to the lighting driver 180 to dim the one or more lights 182 and to change a colour of the one or more lights 182 to a warmer hue in order to implement the romantic ambient. In the embodiment shown in FIGS. 1 and 5, such communication signals received by the lighting driver 180 comprises low-speed communication signals received from the second processing unit 134 (and which may have been originally generated by the first processing unit 132 in response to the user input as described below) or may comprise low-speed communication signals received directly from the first processing unit 132 (e.g., without the second processing unit 134 acting as an intermediary). Specifically referring to FIG. 5, the lighting driver 180 includes low-speed data ports 184A and 184B as a communication interface for receiving the low-speed communication signals. The low-speed data port 184A is operable to receive a wired data connection 213B to couple the lighting driver 180 to the second processing unit 134 or the first processing unit 132. Another low-speed data port 184B is also operable to receive a wired data connection 213C to couple another bathing unit component (in the embodiment shown in FIG. 5, the variable speed pump 150) to the second processing unit 134 via a serial daisy-chain configuration. However, in other embodiments, the communication signals received by the lighting driver 180 may also comprise high-speed communication signals received from the first processing unit 132, such as via the combined high-speed data/low-voltage power port (not shown) described above.

### Audio Component 116

Referring to FIGS. 1 and 5, the audio component 116 may include an audio driver 170 and a plurality of speaker ports 175 for connecting the audio driver 170 to one or more speakers 172 located in or around the receptacle 102. The various elements of the audio component 116 are generally configured to provide audio to users within the receptacle 102 or the field location 101 around the bathing unit system 100 for ambience. In particular, the various elements of the audio component 116, alone or in combination with a first network interface 206 of the first processing unit 132, may allow a user to stream or otherwise broadcast the audio data stored on the user device 136 to the one or more speakers 172 via a wireless network 220. Some embodiments of the bathing unit system 100 may not include the audio component 116.

The audio driver 170 may be powered by the power source 140 (and may relay this power to the one or more speakers 172) and may be responsive to communication signals to cause the one or more speakers 172 to operate in different operational settings. For example, the audio component 116 may be turned on and off, may have different volume settings, may be controlled to stream or project different types of audio data, and/or stream or project different types of audio data over a period of time (e.g., an ambience setting). In the embodiment shown in FIGS. 1 and 5, the audio driver 170 comprises a high-voltage bathing unit component (e.g., a second set bathing unit component) and includes high-voltage element (i.e., active elements such as the one or more speakers 172) which will draw high-voltage power from the power source 140 via the second processing unit 134. Specifically referring to FIG. 5, in the embodiment shown, the audio driver 170 includes a high-voltage power interface 176 for receiving the high-voltage power. The high-voltage power interface 176 is operable to receive a wired power connection 215E which physically couple the audio driver 170 to the second processing unit 134 as described below. The audio driver 170 may then relay the received high-voltage power to the one or more speakers 172 via the plurality of speaker ports 175. In some embodiments, the audio driver 170 may be configured to convert the received high-voltage power into low-voltage power before distributing the converted low-voltage power to the one or more speakers 172 via the plurality of speaker ports 175. Converting the received high-voltage power into the low-voltage power may allow the speaker driver 170 to power a larger number of speakers.

In some embodiments (not shown), the audio driver 170 may also include low-voltage elements (e.g., communication or processing elements such as one or more audio processors for varying or controlling a volume of the one or more speakers 172) which draws the low-voltage power from the power source 140 via the first processing unit 132 or optionally directly from the second processing unit 134. In such embodiments, the audio driver 170 may include a low-voltage power port (not shown) as a power interface for receiving the low-voltage power from either the first processing unit 132 or from the second processing unit 134. Alternatively, the audio driver 170 may utilize low-speed data ports (not shown) as combined low-speed data/low-voltage power ports, and may receive the low-voltage power from the first processing unit 132 (e.g., in embodiments where the first processing unit 132 functions as a master processing unit that generates commands for controlling the one or more speakers 172) or from the second processing unit 134 (e.g., in embodiments where the second processing unit 134 functions as the master processing unit). As a further alternative, the audio driver 170 may utilize the high-speed data port 173 described below as a combined high-speed data/low-voltage power port for receiving both the low-voltage power and the high-speed communication signals from the first processing unit 132. In other embodiments, individual speakers 172 may comprise low-voltage bathing unit components or low-voltage elements which draw the low-voltage power via the first processing unit 132 or optionally directly from the second processing unit 134.

As described above, the audio driver 170 may cause the one or more speakers 172 to operate in different operational settings based on communication signals received from the control system 130. Additionally, the audio driver 170 may also receive audio data from the control system 130 and directing the one or more speakers 172 to project or play the audio data. Due to the complexity and large size of audio data, the audio driver 170 may require the communication signals received from the control system 130 to be the high-speed communication signals to reduce lag in play of the audio data and in user control with respect to the play of the audio data (e.g., play, pause, skip, rewind, etc.). Those skilled in the art will recognize that modern users may become the satisfied with the audio component 116, or the bathing unit system 100 as a whole, if there is significant lag in controlling play of the audio data. Accordingly, and specifically referring to FIG. 5, the audio driver 170 includes the high-speed data port 173 as a communication interface for receiving the high-speed communication signals. The high-speed data port 173 is operable to receive a wired data connection 211B to couple the audio driver 170 to the first processing unit 132. As described above, in embodiments where the audio driver 170 also includes low-voltage elements, the high-speed data port 173 may also comprise a low-voltage power port for transmitting low-voltage power from the first processing unit 132 to the low-voltage elements.

### Visual Display 120

Referring back to FIG. 1, the visual display 120 may generally be located in the area around the bathing unit system 100, and may generally function to display video and provide audio to users within the receptacle 102 or the field location 101 around the bathing unit system 100 for ambience. Similar to the audio component 116, the visual display 120, alone or in combination with the first network interface 206 of the first processing unit 132, may allow a user to stream or otherwise broadcast the audiovisual data stored on the user device 136 to the visual display 120 via the wireless network 220. Some embodiments of the bathing unit system 100 may Not include the visual display 120.

The visual display 120 may be powered by the power source 140 and may be controlled to operate in different operational settings. For example, the visual display 120 may be turned on and off, may have different volume settings, may have different brightness settings, may be controlled to stream or present different types of multimedia data, and/or stream or present different types of multimedia data over a period of time (e.g., an ambience setting). In the embodiment shown in FIG. 1, the visual display 120 is a single smaller display which comprises a low-voltage bathing unit component (e.g., a first set bathing unit component) and includes low-voltage elements, which may draw the low-voltage power from the power source 140 via the first processing unit 132 or optionally directly from the second processing unit 134. Accordingly, the visual display 120 may include a power interface for physically coupling the visual display 120 to the first processing unit 132 or the second processing unit 134. However, those skilled in the art will appreciate that, in other embodiments, such as when the visual display 120 is a large display or when the visual display 120 comprises multiple displays, the visual display 120 may be a high-voltage bathing unit component or include high-voltage elements.

As described above, the visual display 120 may operate in different operational settings based on communication signals received from the control system 130. Additionally, the visual display 120 may also receive audiovisual data from the control system 130 and display or play the audiovisual data. Due to the complexity and large size of the audiovisual data, the visual display 120 may require the communication signals received from the control system 130 to be the high-speed connections signals, again to reduce lag in play of the audiovisual data and in control with respect to the play of the audiovisual data. Accordingly, the visual display 120 to the first processing unit 132. As described below, in some embodiments, the visual display 120 may comprise a combined high-speed data/low-voltage power port for coupling the visual display 120 directly with the first processing unit 132 via a single combined wired data/power connection 211.

### Power Source 140

Referring still to FIGS. 1 and 5, the power source 140 may supply any conventional power service suitable for residential or commercial use. For example, the power source 140 may supply 240 or 120 V AC to the control system 130 via a service wiring 217 as described in greater detail below. Those skilled in the art will appreciate that other voltage supply values or voltage supply combinations are possible. For example, the voltage supply values may be different depending on geographical location. Additionally, other embodiments of the bathing unit system 100 include more than one power source 140, an individual power source 140 for each bathing unit component, or a power source 140 which is shared by more than one bathing unit component (but not by all bathing unit components) of a particular bathing unit system 100.

After receipt of the power from the power source 140, the control system 130 may be configured to distribute the power to the different bathing unit components to operate the different bathing unit components according to different operational modes as described above. As will be described below, the control system 130 may include the first processing unit 132 configured to adapt the power received from the power source 140 (via the second processing unit 134) from a source voltage (e.g., 240V or 120V) into a low-voltage to be supplied to a first set of the bathing unit components described above (also referred to as “first set bathing unit components” or “low-voltage bathing unit components”), or to low-voltage elements of a bathing unit component having both high and low-voltage elements. The control system 130 also includes the separate second processing unit 134 configured to adapt the power received from the power source 140 from the source voltage into a high-voltage to be supplied to a second set of bathing unit components described above (also referred to as “second set bathing unit components” or “high-voltage bathing unit components”), or to high-voltage elements of a bathing unit component having both high and low-voltage elements. In some embodiments, the second processing unit 134 is also configured to adapt the power received from the power source 140 from the source voltage into a low-voltage; however, the first processing unit 132 is not capable of adapting, or operable to adapt, the power received from the power source 140 from the source voltage into a high-voltage or of supplying or distributing the high-voltage power.

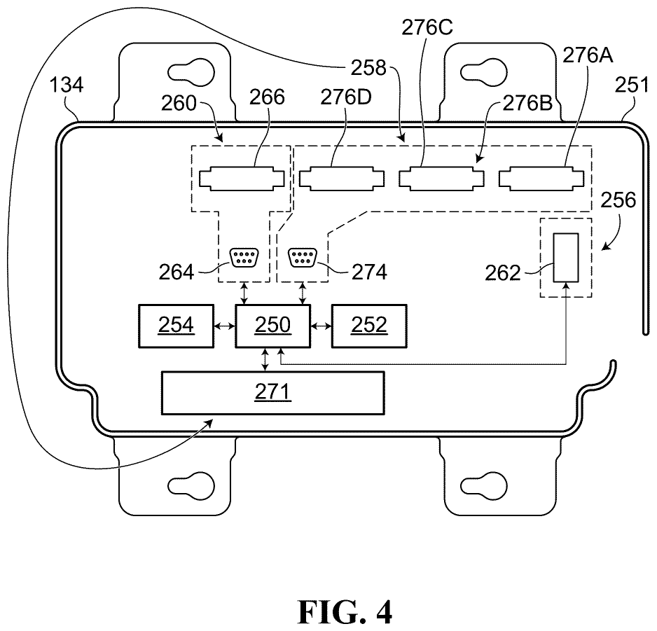

Further, in the embodiment shown, the power source 140 is directly coupled only to the second processing unit 134. The first processing unit 132 does not include a power interface to directly couple to the power source 140. In this regard, referring to FIGS. 4 and 5, in the embodiment shown, the second processing unit 134 includes a second power interface 256 comprising a source power port 262 forming a power interface with the power source 140. The source power port 262 is adapted to receive the service wiring 217 to physically couple the second processing unit 134 and the power source 140. The second power interface 256 also includes various adapters and components for converting the received power at the source voltage into power at the high-voltage. The second processing unit 134 then relays the high-voltage power to the first processing unit 132 via a second processor interface 260 as described below and to the first set bathing unit components via the second component interface 258 as described below. In the embodiment shown, the first processing unit 132 does not include a power interface to directly couple the first processing unit 132 to the power source 140. Rather, the first processing unit 132 receives power from the second processing unit 134 via first and second processor interfaces 210 and 260 as described below. However, in other embodiments, the first processing unit 132 may include a power interface to directly couple the first processing unit 132 to the power source 140.

### Control System 130

As described above, the bathing unit system 100 includes the control system 130 in communication with the different bathing unit components and the power source 140. The control system 130 is generally configured to: (A) transmit communication signals to activate and deactivate the different bathing unit components to control the bathing unit system 100 to initiate bathing sessions for users; (B) receive user input (e.g., received via the topside control panel 138 or the user device 136) for said activation and deactivation of the bathing unit components; (C) transmit software/firmware updates to the bathing unit components (e.g., received via the topside control panel 138, the user device 136 or the control server 131); (D) receive, store and process information received from the bathing unit components (e.g., particularly from the sensors 112, such as a temperature of the water 103 in the receptacle 102, temperature of the water 103 in the circulation system 104, ambient temperature at the field location 101, pH of the water 103 in the circulation system 104, turbidity of the water 103 in the circulation system 104, etc.) in order to implement the bathing sessions, and to operate/maintain the bathing unit system 100; and (E) supply power to the various bathing unit components coupled to the control system 130.

In the embodiment shown in FIGS. 1 and 5, the control system 130 includes the first processing unit 132 and the second processing unit 134, which may be configured to communicate with at least one control device associated with the bathing unit system 100. The control device may be the control server 131, the topside control panel 138, or a bathing unity system control application stored on the user device 136. Those skilled in the art will appreciate that the control device may comprise any control device which is operable to control the different bathing unit components and to receive information from the different bathing unit components.

The first processing unit 132, the second processing unit 134, and the topside control panel 138 may be located physically near (e.g., at the same field location 101) the bathing unit system 100. In contrast, the control server 131 and the user device 136 may be located (or moved to be) physically separate (e.g., in a different building from) the bathing unit system 100. In some embodiments, the first processing unit 132, the second processing unit 134, the control server 131, the topside control panel 138 and/or the user device 136 may collaborate with each other to implement different processes, or different parts of the processes.

### First Processing Unit 132

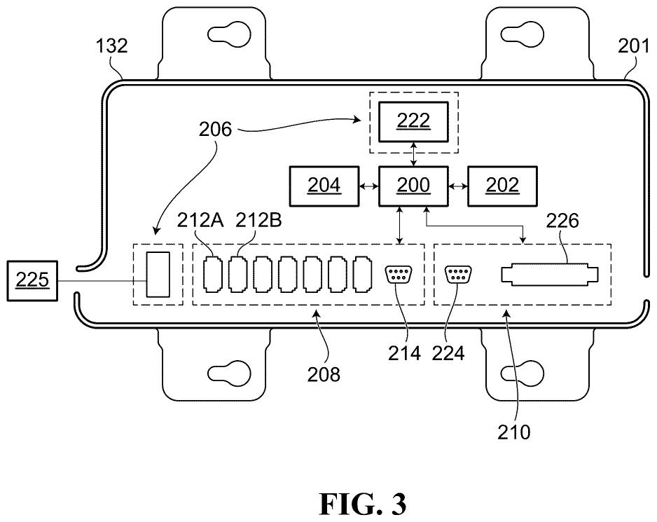

Referring to FIG. 3, the first processing unit 132 includes a first local processor 200, a first storage memory 202, a first program memory 204, the first network interface 206, the first component interface 208, and a first processor interface 210, all in communication with the first local processor 200. Other embodiments of the first processing unit 132 may include fewer, additional or alternative components. A primary role of the first processing unit 132 is to process and directly transmit commands and software/firmware updates to certain first set bathing unit components directly physically coupled to the first processing unit 132 (via the first component interface 208) using high-speed communication signals, and to receive information from such bathing unit components using the high-speed communication signals, whereby the high-speed communication signals may be required for performance and/or data fidelity of these bathing unit components. A further role of the first processing unit 132 is to transmit commands and updates to certain second set bathing unit components directly physically coupled to the second processing unit 134 (via the first processor interface 210, the second processor interface 260 and then the second component interface 258) using the low-speed communication signals. A further role of the first processing unit 132 is to supply/distribute low-voltage power to certain first set bathing unit components directly physically coupled to the first processing unit 132 (again, via the first component interface 208). In the embodiment shown, the first processing unit 132 is not capable of (or operable to) supplying or distributing the high-voltage power.

The first storage memory 202 stores information received or generated by the first local processor 200 and may generally function as an information or data store. The first program memory 204 stores various blocks of code (alternatively called processor-executable instructions and/or computer-executable instructions), for directing the first local processor 200 to perform various processes. The first program memory 204 may also store database management system computer-executable instructions for managing the data stores in the first storage memory 202. The first storage memory 202 and the first program memory 204 may each be implemented as one or a combination of a non-transitory computer-readable medium and/or non-transitory machine-readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching thereof).

The first local processor 200 is generally configured to execute instructions stored in the first program memory 204, to retrieve information from, and store information into, the data stores of the first storage memory 202, and to receive information (and power) from, and transmit commands and updates to, the bathing unit system components (either directly coupled to the first processing unit 132 or directly coupled to the second processing unit 134), the second processing unit 134, the topside control panel 138, the user device 136 and/or the control server 131 using a combination of the first network interface 206, the first component interface 208 and the first processor interface 210 as described below.

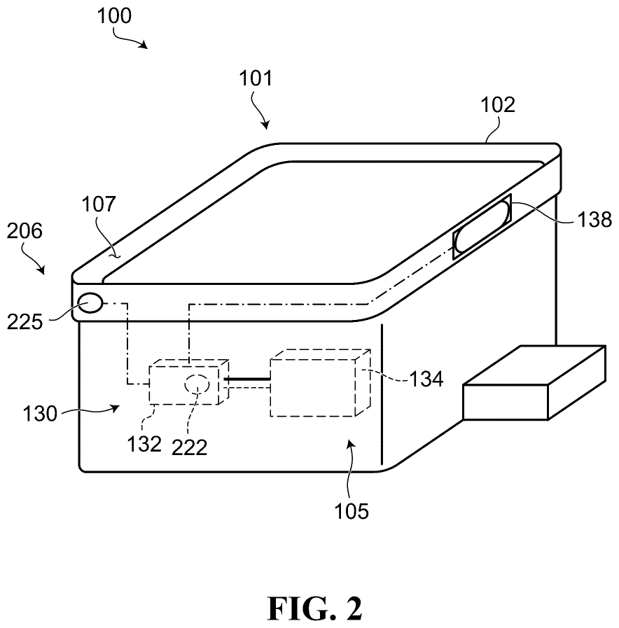

Referring now to FIG. 3, the first processing unit 132 may be a single physical unit comprising a substantially enclosed first body 201 containing all (or a majority) of the components of the first processing unit 132. In the embodiment shown, the first body 201 of the first processing unit 132 comprises a single physical unit enclosing the first local processor 200, the first storage memory 202, the first program memory 204, some ports of the first network interface 206, all ports of the first component interface 208 and all ports of the first processor interface 210. As described below, a few ports of the first network interface 206 are located outside of the physical unit of the first body 201 and may be located around a perimeter of the bathing unit system 100 (e.g., a corner of a spa shell 107 of the bathing unit system 100, rather than within the spa cabinet 105, as shown in FIG. 2) for increased signal and connectivity over the wireless network 220, as described in U.S. application Ser. No. 18/917,470, entitled “METHOD AND SYSTEM FOR PROVIDING CONNECTIVITY FOR A BATHING UNIT SYSTEM 100,” filed on Oct. 16, 2024, the contents of which are incorporated by reference herein. The single physical first body 201 of the first processing unit 132 may be watertight due to the moist environment of the bathing unit system 100. The single physical first body 201 of the first processing unit 132 may be positioned within the spa cabinet 105, and may not be externally visible to a user of the bathing unit system 100.

### First Network Interface 206

Referring to FIGS. 2, 3 and 5, the first network interface 206 comprises a communication interface for the first local processor 200 to communicate commands to, and receive information from, various remote servers and/or remote devices, and in particular control devices which may be remote servers or remote devices (e.g., the control server 131 and the user device 136). In the embodiment shown, the first network interface 206 allows the first local processor 200 to communicate with these remote servers and/or remote devices over the wireless network 220 (e.g., a Wi-Fi network, a Bluetooth network, a radio frequency (RF) network or a cellular network). However, in other embodiments, the first network interface 206, alone or in combination with others of the first interfaces 208 and 210, may comprise interfaces/ports which allow the first local processor 200 to communicate with a particular remote server or remote device via a wired connection (e.g., a USB connection, an Ethernet connection, etc.).

The remote servers and/or the remote devices may include, without limitation, (a) the control server 131, (b) the user device 136 which may be associated with a user of the bathing unit system 100, and/or (c) one or more external systems (e.g., a server associated with a weather provider, a server associated with a calendar service, a server associated with a news provider, etc.) separate from the bathing unit system 100. The information received from the remote servers and/or the remote devices may be first set commands for controlling one or more of the first set bathing unit components physically coupled to the first processing unit 132 and/or second set commands for controlling one or more of the second set bathing unit components physically coupled to the second processing unit 134. For example, a user may enter a command for controlling the bathing unit system 100 using a graphical user interface (GUI) implemented via a mobile application installed on the user device 136. The information received from the remote servers and/or the remote devices may also be first set updates for updating one or more of the first set bathing unit components physically coupled to the first processing unit 132 and/or second set updates for updating one or more of the second set bathing unit components physically coupled to the second processing unit 134. For example, a spa manufacturer may upload a software update for the bathing unit system 100 (or certain bathing unit components) via the control server 131 to be pushed out to a plurality of different ones of the bathing unit systems 100. The first network interface 206 may allow the first processing unit 132 to function as the master processing unit of the bathing unit system 100 and generate various commands for controlling, and receive various information from, different bathing unit components (e.g., both the first set bathing unit component and the second set bathing unit component), as well as distribute various updates to the different bathing unit components.

The first network interface 206 may include transceivers and communication devices of various different types as described in U.S. application Ser. No. 18/917,470, entitled “METHOD AND SYSTEM FOR PROVIDING CONNECTIVITY FOR A BATHING UNIT SYSTEM,” filed on Oct. 16, 2024, the contents of which are incorporated by reference herein. In the specific embodiment shown in FIGS. 2 and 3, the first network interface 206 comprises a Bluetooth transceiver 222 located within the single physical first body 201 of the first processing unit 132 and a transceiver port 225 located outside of the physical first body 201 of the first processing unit 132 at a corner of the spa shell 107. The Bluetooth transceiver 222 allows the first local processor 200 to receive commands and information from a remote device (e.g. the user device 136) generally proximate the bathing unit system 100 at the field location 101 over a Bluetooth network. More specifically, the Bluetooth transceiver 222 allows the first local processor 200 to receive audio data to be projected using the audio component 116 and audiovisual data to be displayed using the visual display 120. In specific practical implementations, the transceiver port 225 may be configured to receive a Wi-Fi transceiver, a cellular transceiver, a combined Wi-Fi and cellular transceiver, a Bluetooth transceiver, a combined Bluetooth and Wi-Fi transceiver, etc. Once the corresponding transceiver is received in the transceiver port 225, the received transceiver allows the first local processor 200 to receive commands and information from the remote servers and/or the remote devices a Bluetooth, a Wi-Fi or a cellular network as applicable. Those skilled in the art will appreciate that alternative embodiments of the first network interface 206 may include alternative or additional transceivers and communication devices which allow the first local processor 200 to communicate with the remote servers and/or the remote devices separate from the bathing unit system 100.

### First Component Interface 208

Referring now to FIGS. 3 and 5, the first component interface 208 includes a high-speed communication interface for the first local processor 200 to communicate commands and updates to, and receive information from, the bathing unit components using the high-speed communication signals. Different from the first network interface 206, in the embodiment shown, the first component interface 208 allows the first local processor 200 to communicate with these bathing unit components over a wired high-speed data connection. However, in other embodiments, the first component interface 208 (alone or in combination with others of the first interfaces 206 and 210) may comprise ports/interfaces which allow the first local processor 200 to communicate with different bathing unit components via the wireless network 220. The bathing unit components coupled to the first component interface 208 may comprise the bathing unit components which receive or transmit high volume or complex data requiring the high-speed communication signals for performance and/or fidelity. For example, these bathing unit components may include the audio component 116 configured to receive and project/play audio data, the visual display 120 configured to receive and display/play audiovisual data, some of the sensors 112 (e.g., a camera sensor 164 described above) configured to capture complex data metrics including image data or sound data. Those skilled in the art will appreciate that additional or alternative bathing unit components requiring the high-speed communication signals are possible.

The first component interface 208 may include a power interface which enable the first processing unit 132 to supply low-voltage power from the power source 140 to different bathing unit components physically coupled to the first component interface 208 via a wired low-voltage power connection. The bathing unit components may comprise the first set bathing unit components which draw the low-voltage from the power source 140 (e.g., the low-voltage bathing unit components) or may include the low-voltage elements. For example, these first set bathing unit components may comprise the audio component 116, the visual display 120, the control panel 138, and some sensors 112. These low-voltage bathing unit components may also include low-voltage elements (e.g., the sensing elements, the processing elements, or the communication elements) of bathing unit components including both high-voltage elements and low-voltage elements (e.g., the variable speed pump 151 and the heater 145) as described below. Those skilled in the art will appreciate that additional or alternative bathing unit components only requiring low-voltage power are possible. The first component interface 208 may also include the required hardware for adapting a source voltage of the power received from the power source 140 (via the second processing unit 134) into a required low-voltage.

In some embodiments, the first component interface 208 may also include a low-speed communication interface for the first local processor 200 to communicate commands to, and receive information from, the bathing unit components using the low-speed communication signals. The first component interface 208 may be configured to communicate over a wired low-speed data connection. These bathing unit components may comprise bathing unit components which receive or transmit less complex data. For example, these bathing unit components may comprise the variable speed pump 151, the filter 108, the temperature change component 110, the lighting component 118, some of the sensors 112 (e.g., a receptacle temperature sensor 160 or a pH sensor 162 as described below) configured to capture simple data metrics including numerical values for example. Those skilled in the art will appreciate that additional or alternative bathing unit components which are operable using only the low-speed communication signals are possible.

In particular, the first component interface 208 may allow the first processing unit 132 and the first set bathing unit components to be directly and physically coupled via a wired connection for (A) transmission of the high-speed communication signals as between the first processing unit 132 and the connected bathing unit components; (B) transmission of the low-speed communication signals as between the first processing unit 132 and the connected bathing unit components; and (C) transmission of the low-voltage power as between the first processing unit 132 and the connected bathing unit components. The first component interface 208 may include any interface which enables the first processing unit 132 to perform the functions as described above and below, including specialized or standard interface technologies such as channel, port-mapped, asynchronous for example. For example, referring now to FIGS. 3 and 5, the first component interface 208 includes: (A) a plurality of high-speed data/low-voltage power ports 212A and 212B operable to receive wired data/power connections 211A and 211B for transmission of both the high-speed communication signals and the low-voltage power; and (B) one or more low-speed data ports 214 operable to receive a wired data connection 213 for transmission of the low-speed communication signals (e.g., in a serial daisy-chain configuration). Those skilled in the art will appreciate that additional or alternative interfaces which allow the first component interface 208 to perform the functions described above and below are possible, such as a separate high-speed data port operable for transmission of the high-speed communication signals only, a separate low-voltage power port operable for transmission of the low-voltage power only, or a combined low-speed data/low-voltage power port operable for transmission of both the low-speed communication signals and the low-voltage power for example.

The plurality of high-speed data/low-voltage power ports 212A and 212B may allow both data and power transfer between the first processing unit 132 and the connected first bathing unit components. In some embodiments, the plurality of high-speed data/power ports 212A and 212B comprise USB ports (e.g., USB-A, USB-B, USB-C, micro USB, mini USB, etc.), 8-pin Lightning ports, Ethernet ports, HDMI ports, etc. Correspondingly, the wired data/power connections 211A and 211B allows both data and power transfer between the first processing unit 132 and the connected bathing unit components. The high-speed data/low-voltage power ports 212A and 212B may also allow the first local processor 200 to automatically derive identification information for specific bathing unit components of a plurality of first set bathing unit components physically coupled to the first processing unit 132 and to automatically adjust how each bathing unit component is controlled at least in part based on the derived identification information.

In some embodiments, a bathing unit component coupled to one of the high-speed data/low-voltage power ports 212A and 212B may receive both high-speed communication signals and low-voltage power. For example, referring to FIG. 5, the topside control panel 138 is physically and directly coupled to the high-speed data/low-voltage power port 212A of the first processing unit 132 via the wired data/power connection 211A. The topside control panel 138 is not directly coupled to the second processing unit 134. In some embodiments, the topside control panel 138 may require the high-speed communication signals for performance and fidelity. For example, the topside control panel 138 may be configured to receive a wide variety of different user inputs from a user of the bathing unit system 100, and such user inputs may include a wide variety of different data types which may be more efficiently and effectively transmitted via the high-speed communication signals. Further, in the embodiment shown in FIGS. 1 and 5, the first processing unit 132 may generally function as a master processing unit of the bathing unit system 100 and may have increased processing power when compared to the second processing unit 134. Further still, as described above, the first network interface 206 generally allow the first processing unit 132 to receive other user inputs and other data requiring complex processing from remote servers and/or remote devices (e.g., the user device 136 and the control server 131). In such embodiments, it may be more schematically efficient (e.g., to reduce the number of wired connections 211, 213 and 215 between the different bathing unit components and the first and second processing units 132 and 134) and more computationally efficient to concentrate complex processing in the first processing unit 132 (rather than split the processing between the first and second processing units 132 and 134). Additionally, by isolating complex processing in the first processing unit 132 (which may generate a significant amount of heat) and by isolating supply of the high-voltage power in the second processing unit 134 (which may also generate a significant amount of heat), functionalities generating heat is split between the first and second processing units 132 and 134 to prevent overheating of the single physical body 201 and 251 forming the first and second processing units 132 and 134. Based on the above example, those skilled in the art will recognize that, in the bathing unit system 100, bathing unit components which can operate using the low-voltage power, but which require the high-speed communication signals generally comprise first set bathing unit components which are directly physically coupled with the first processing unit 132 via the wired data/power connection 211.

In other embodiments, a bathing unit component coupled to one of the high-speed data/low-voltage power ports 212A and 212B may be a bathing unit component which is capable of operating using only the low-voltage power and is capable of communication using either the high-speed communication signals or the low-speed communication signals. For example, in some embodiments, the topside control panel 138 may be capable of communication using either the high-speed communication signals or the low-speed communication signals, and may be capable of operating using the low-voltage power, as some embodiments of the topside control panel 138 may generally have a small display and modest processing requirements. In such embodiments, even if the topside control panel 138 does not require the high-speed communication signals, it may still be more schematically efficient (e.g., again to reduce the number of wired connections 211, 213 and 215) to couple the control panel 138 to the first processing unit 132 over the single wired data/power connection 211A rather than having separate wired connections 213 and 215 for power and data.

In yet other embodiments, a bathing unit component coupled to one of the high-speed data/low-voltage power ports 212A and 212B may be a bathing unit component which requires the high-speed communication signals from the first processing unit 132, but requires the high-voltage power from the second processing unit 134. For example, referring again to FIGS. 1 and 5, the audio component 116 is physically coupled to the first processing unit 132 over the wired data/power connection 211B via the high-speed data/low-voltage power port 212B and is also physically coupled to the second processing unit 134 over the wired power connection 215E via a high-voltage power relay 276B as described below. In this regard, the audio component 116 may require the high-speed communication signals from the first processing unit 132 for performance and fidelity. For example, as described above, the audio component 116 may be configured to receive and project/play complex audio data, and such audio data requires the high-speed communication signals from the first processing unit 132 to prevent lagging and skipping of an audio track. Additionally, a user may wish to broadcast the audio track from the user device 136 using the wireless network 220 (e.g., via the Bluetooth network). As described below, the second processing unit 134 may not include a network interface for communicating with remote servers and/or remote devices and may not be capable of communicating over the wireless network 220. Additionally, it may be more computationally efficient and may result in better audio performance or fidelity if the audio data was transmitted directly from the first processing unit 132 to the audio component 116 (without requiring further relay to the second processing unit 134). Requiring the first processing unit 132 to initially relay the audio data to the second processing unit 134 may result in a lag between when a user provides a user input for playing, pausing, skipping, etc. a particular audio track and when the audio component 116 eventually receives and implements the user input. This lag may cause user dissatisfaction with the audio component 116.

The low-speed data/low-voltage power port 214 allows data transfer via the low-speed communication signals between the first processing unit 132 and the connected bathing unit components. The low-speed data/low-voltage power port 214 may also allow the first processing unit 132 to distribute the low-voltage power to the connected bathing unit components. In some embodiments, the low-speed data/low-voltage power port 214 includes a RS port (e.g., RS-485 ports, RS-232 ports, RS-422 ports), a I2C port, or an older USB port (e.g., USB 1.0). Correspondingly, the wired connection 213 allows data transfer via the low-speed communication signals between the first processing unit 132 and the connected bathing unit components, and optionally also the distribution of low-voltage power from the first processing unit 132 to the connected bathing unit components. In the embodiment shown in FIGS. 1 and 5, the first processing unit 132 does not have any bathing unit components coupled to the low-speed data/low-voltage power port 214. The low-speed data/low-voltage power port 214 may be used if the second processing unit 134 runs out of low-speed data ports or becomes overheated if further bathing unit components are coupled to the second processing unit 134 or it is more schematically efficient (e.g., to reduce the number of wired connections 211, 213 and 215) to couple the bathing unit component to the first processing unit 132.

Generally based on the examples above, those skilled in the art will recognize that the first component interface 208 allows the first processing unit 132 to be physically coupled to the different bathing unit components as follows:
(A) Bathing unit components which require high-speed communication signals for performance and/or fidelity may be (and are typically) directly and physically coupled to the first processing unit 132, irrespective of whether such bathing unit components require low-voltage power or high-voltage power to operate. In this regard, in the embodiment shown, as between the first and second processing units 132 and 134, only the first processing unit 132 is capable of providing high-speed communication signal.
(B) Bathing unit components which are capable of operating using only the low-voltage power may also be directly and physically coupled to the first processing unit 132, irrespective of whether such bathing unit components require the high-speed communication signals or is capable of operating using the low-speed communication signals. In this regard, the first component interface 208 is adapted to provide both the low-voltage power and the high-speed communication signals via a single high-speed data/low-voltage power port 212 and a single wired data/power connection 211, which may increase processing and schematic efficiency. Further, the first component interface 208 may also be also be adapted to provide both the low-voltage power and the low-speed communication signals via a single low-speed data/low-voltage power port 214 and a single wired connection 213.
(C) Bathing unit components which require high-speed communication signals for performance and/or fidelity and require high-voltage power for operation are typically
directly and physically coupled to both the first processing unit 132 (via the high-speed data/low-voltage power port 212) and the second processing unit 134 (via a high-voltage power relay 276). In this regard, in the embodiment shown, as between the first and second processing units 132 and 134, only the second processing unit 134 is capable of providing the high-voltage power.

### First Processor Interface 210

The first processor interface 210 includes a communication interface for the first local processor 200 to communicate commands and software/firmware updates to, and receive information from, a second local processor 250 of the second processing unit 134 and the second set bathing unit components coupled to the second processing unit 134. In this regard, commands and updates received by the first processing unit 132 (e.g., user inputs and software/firmware updates received via the first network interface 206 from the user device 136 and/or the control server 131 or via the first component interface 208 from the topside control panel 138) may be transferred or relayed to the second processing unit 134 and the second set bathing unit components coupled to the second processing unit 134 over the first processor interface 210. In the embodiment shown in FIGS. 1 and 5, the first processor interface 210 allows the first and second local processors 200 and 250 to communicate over a wired low-speed data connection. However, in other embodiments, the first processor interface 210, alone or in combination with others of the first interfaces 206 and 208, may comprise ports/interfaces which allow the first local processor 200 to communicate with the second local processor 250 via the wireless network 220 (e.g., an inductive network, the Wi-Fi network, the RF network, the Bluetooth network, or the cellular network).

The first processor interface 210 may also include a power interface for the first processing unit 132 to distribute low-voltage power to the second set bathing unit components coupled to the second processing unit 134. In the embodiment shown in FIGS. 1 and 5, the first processor interface 210 allows the first processing unit 132 to transfer low-voltage power over a wired combined low-speed data/low-voltage power connection.

The first processor interface 210 may also include a power interface for the first processing unit 132 to receive high-voltage power from the power source 140 via the second processing unit 134. As such, the first processing unit 132 may also be a high-voltage component (or includes high-voltage elements) physically coupled to the second processing unit 134. In the embodiment shown in FIGS. 1 and 5, the first processor interface 210 allows the first and second processing units 132 and 134 to transfer power over a wired high-voltage power connection.

Accordingly, the first processor interface 210 may allow the first processing unit 132 and the second processing unit 134 to be directly and physically coupled via a wired connection, for (A) transmission of the low-speed communication signals from the first processing unit 132 to the second processing unit 134 and the second set bathing unit components coupled to the second processing unit 134, (B) distribution of the low-voltage power from the first processing unit 132 to the second set bathing unit components coupled to the second processing unit 134 and (C) distribution of high-voltage power from the second processing unit 134 to the first processing unit 132. The first processor interface 210 may comprise any interface which enables the first processing unit 132 to perform the functions as described above and below, including specialized or standard interface technologies such as channel, port-mapped, asynchronous for example. For example, referring now to FIGS. 3 and 5, the first processor interface 210 includes: (A) a low-speed data/low-voltage power port 224 operable to receive the wired connection 213A for transmission of the low-speed communication signals and, optionally, distribution of the low-voltage power both from the first processing unit 132; and (B) a high-voltage power port 226 operable to receive a wired power connection 215A for transmission of the high-voltage power. Those skilled in the art will appreciate that additional or alternative interfaces which allow the first processor interface 210 to perform the functions as described above and below are possible, such as a combined low-speed data/high-voltage power port operable for transmission of both the low-speed communication signals and the high-voltage power for example.

The low-speed data/low-voltage power port 224 allows data transfer via the low-speed communication signals between the first processing unit 132 and the connected second processing unit 134, as well as between the first processing unit 132 and the second set bathing unit components coupled to the second processing unit 134. The low-speed data/low-voltage power port 224 may also allow the first processing unit 132 to distribute low-voltage power to the second set bathing unit components coupled to the second processing unit 134. Correspondingly, the wired connection 213A coupling the low-speed data/low-voltage power port 224 to the second processing unit 134 also allows data transfer via the low-speed communication signals and power transfer via the low-voltage power. In the embodiment shown in FIGS. 3 and 5, the low-speed data/low voltage power port 224 comprises a RS-485 port. In other embodiments, the low-speed data/low-voltage power port 224 comprises the RS port (e.g., RS-485 ports, RS-232 ports, RS-422 ports), the I2C port, the older USB port (e.g., USB 1.0), etc. The low-speed data/low-voltage power port 224 generally allows the first processing unit 132 to transmit commands (e.g., received via the user input) and software/firmware updates to the second processing unit 134, and to bathing unit components coupled to the second processing unit 134 as described below. Correspondingly, the low-speed data/low-voltage power port 224 also allows the first processing unit 132 to receive information from the second processing unit 134, and from the bathing unit components coupled to the second processing unit 134. The low-speed data/low-voltage power port 224 also allows the first processing unit 132 to distribute low-voltage power to the bathing unit components coupled to the second processing unit 134.

The high-voltage power port 226 allows only power transfer between the first processing unit 132 and the connected second processing unit 134. Correspondingly, the wired power connection 215 coupling the high-voltage power port 226 to the second processing unit 134 also allows only power transfer. The high-voltage power port 226 generally allows the first processing unit 132 to receive high-voltage power from the power source 140 via the second processing unit 134.

### Second Processing Unit 134

Referring now to FIGS. 2, 4, and 5, the second processing unit 134 may include the second local processor 250, a second storage memory 252, a second program memory 254, the second power interface 256, the second component interface 258, and the second processor interface 260, all in communication with the second local processor 250. Other embodiments of the second processing unit 134 may include fewer, additional or alternative components. A primary role of the second processing unit 134 is to supply/distribute high-voltage power from the power source 140 to both the first processing unit 132 and different bathing unit components in the bathing unit system 100. In some embodiments, the second processing unit 134 is also capable of supplying/distributing low-voltage power from the power source 140 to both the first processing unit 132 and different bathing unit components in the bathing unit system 100, by supplying the high-voltage power to a converter (e.g., via the audio driver 170 and/or the lighting driver 180) or by supplying the low-voltage power directly (e.g., via the second component interface 258). Another role of the second processing unit 134 is to allow commands and software/firmware updates from the first processing unit 132 to be transmitted to the bathing unit components and also to allow information from the different bathing unit components to be transmitted to the first processing unit 132. In the embodiment shown, the second processing 134 is not capable of (or operable to) communicating using high-speed communication signals, does not perform any significant processing of commands or information, and does not perform any significant controlling of the different bathing unit components coupled to either the first or the second processing units 132 and 134. As described above, by separating the provision of high-voltage power (via the second processing unit 134) and low-voltage power (via the first processing unit 132) into two different processing units, additional bathing unit components (e.g., additional sensors, additional pumps, additional air blowers, etc.) may be coupled to the control system 130 without overheating a particular processing unit. Further, distribution of high-voltage power and data processing are two functionalities required of the control system 130 which may generate a significant amount of heat. Separating these two functionalities as between the first and second processing units 132 and 134 (e.g., using the first processing unit 132 to perform data processing and using the second processing unit 134 to supply high-voltage power), overheating of a particular processing unit may also be avoided. Further still, by isolating the data processing in the first processing unit 132, the data processing functionality of a particular control system 130 can be a replaced without affecting other components of the control system 130 (e.g., in situations where higher processing power is required, or where data processing components require repair). Similarly, by isolating the distribution of high-voltage power in the second processing unit 134, the power distribution functionality of the particular control system 130 can be replaced or switched without affecting other components of the control system 130 (e.g., in situations where a particular set of high-power relays switches off). Further, the separation of the first and second processing units 132 and 134 allow different versions of the first and second processing units 132 and 134 to be combined together. For example, the second processing unit 134 may be available in a 120V version for smaller bathing unit systems 100 and a 220V version for larger bathing unit systems 100. Both versions of the second processing unit 134 may be combined with a same version of the first processing unit 132 without requiring a more complicated combined product. Similarly, the first processing unit 132 may include a standard version without certain transceiver capabilities (e.g., without the Bluetooth transceiver 222 and/or without the transceiver port 225) and a premium version with the transceiver capabilities. Both versions of the first processing unit 132 may be combined with a same version of the second processing unit 134 without requiring a more complicated combined product.

The second storage memory 252 stores information received or generated by the second local processor 250 and may generally function as an information or data store. The second program memory 254 stores various blocks of code (alternatively called processor-executable instructions and/or computer-executable instructions), for directing the second local processor 250 to perform various processes, including (A) in some embodiments, directing the second local processor 250 to relay commands and/or updates to the bathing unit component physically coupled to the second processing unit 134, (B) in some embodiments, directing the second local processor 250 to relay information to the first processing unit 132, and (C) directing the second local processor 250 to distribute the high-voltage power to the bathing unit components and to the first processing unit 132. The second storage memory 252 and the second program memory 254 may each be implemented as one or a combination of a non-transitory computer-readable medium and/or non-transitory machine-readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching thereof).

The second local processor 250 is generally configured to perform the operations of the second processing unit 134 (e.g., by executing instructions stored in the second program memory 254); retrieve information from, and store information into the data stores of the first storage memory 204; to receive power at the source voltage from the power source 140 and distribute power at the high-voltage to the bathing unit component and the first processing unit 132 using a combination of the second power interface 256, the second component interface 258 and the second processor interface 260 as described below.

Similar to the first processing unit 132, the second processing unit 134 may be a single physical unit comprising the substantially enclosed second body 251 containing all (or a majority) of the components of the second processing unit 134. For example, referring to FIG. 4, the second body 251 of the second processing unit 134 comprises a single physical unit enclosing the second local processor 250, the second storage memory 252, the second program memory 254, all of the ports/interfaces of the second power interface 256 and all of the ports/interfaces of the second component interface 258 and all of the ports/interfaces of the second processor interface 260. Again, similar to the first processing unit 132, the single physical second body 251 of the second processing unit 134 may be watertight due to the moist environment of the bathing unit system 100. The single physical second body 251 of the second processing unit 134 may be positioned within the spa cabinet 105, and may not be externally visible to a user of the bathing unit system 100.

In the embodiment shown in FIGS. 4 and 5, unlike the first processing unit 132, the second processing unit 134 typically will not include a network interface and may not be capable of communicating directly with remote servers or remote devices (e.g., the user device 136 and the control server 131). In this regard, isolating the network interface to the first processing unit 132 may further allow the network connectivity of a particular control system 130 to be replaced or switched without affecting other components of the control system 130 (e.g., in situations where a different level or type of connectivity over the wireless network 220 is required). However, in some embodiments, the second processing unit 134 may be physically connected with external radio frequency (RF) or other wireless transmission modules via a wired data connection (not shown), and may communicate with the remote servers or remote devices via that separate transmission module. However, such separate transmission modules typically include a component that is located outside of the spa cabinet 105 (e.g., a spa module which is coupled to the second processing unit 134 and a home module which is coupled to router of a house at the field location 101, where the home module may be located outside of the spa cabinet 105).

### Second Power Interface 256

Referring to FIGS. 1, 4 and 5, the second power interface 256 comprises a power interface for the second processing unit 134 receive power from the power source 140. The second power interface 256 may also include the required hardware for adapting a source voltage of the power received from the power source 140 into a required high-voltage. In the embodiment shown, the second power interface 256 allows the second processing unit 134 to receive power from the power source 140 via a wired power connection.

The second power interface 256 may comprise any interface which enables the second processing unit 134 to perform the functions as described above and below, including specialized or standard interface technologies such as channel, port-mapped, asynchronous for example. Referring specifically to FIGS. 4 and 5, the second power interface 256 includes

the source power port 262 operable to receive the service wiring 217 for transmission of the power at the source voltage. The source power port 262 allows only power transfer between the second processing unit 134 and the power source 140. Correspondingly, the service wiring 217 coupling source power port 262 to the power source 140 allows only power transfer.

### Second Component Interface 258

Referring to FIGS. 1, 4 and 5, the second component interface 258 includes a communication interface for the second local processor 250 to communicate commands and updates to, and receive information from, the bathing unit components using low-speed communication signals. In the embodiment shown, the second component interface 258 is configured to transmit the low-speed communication signals over a wired low-speed data connection. However, in other embodiments, the second component interface 258, alone or in combination with the second processor interface 260, may comprise ports or interfaces which allow the second local processor 200 to transmit the low-speed communication signals to the connected bathing unit components via the wireless network 220 (e.g., the Wi-Fi network, the Bluetooth network, the RF network or the cellular network). The bathing unit components coupled to the second component interface 258 may comprise bathing unit components which are capable of operating using commands received over a lower-speed connection, and are in turn configured to operate based on (or generate) less complex data. For example, such bathing unit components may include the variable speed pump 151, the filter 108, the heater 145, some of the sensors 112 (e.g., the receptacle temperature sensor 160 or the pH sensor 162) configured to capture simple data metrics including numerical values, etc. Those skilled in the art will appreciate that additional or alternative bathing unit components which are capable of operating based on the low-speed communication signals are possible.

The second component interface 258 also includes a power interface which enables the second processing unit 134 to supply high-voltage power from the power source 140 to different bathing unit components physically coupled to the second component interface 208 via a wired high-voltage power connection. These bathing unit components may comprise the second set bathing unit components which draw the high-voltage power from the power source 140 (e.g., the high-voltage bathing unit components) or may include the high-voltage elements. For example, these second set bathing unit components may comprise the audio component 116, the visual display 120, the lighting component 118, the variable speed pump 151, the standard pump 150, the heater 145, certain power intensive sensors 112, etc. These high-voltage bathing unit components may also specifically include high-voltage elements (e.g., the active elements) of some bathing unit components (e.g., the motor of the variable speed pump 151 and the heating element of the heater 145) as described above. The second component interface 258 may also including the required hardware for adapting a source voltage of the power received from the power source 140 into a suitable high-voltage for the connected bathing unit components, such as from a source voltage of 220V to a suitable high-voltage of 120V for example. In other embodiments, the source voltage and the suitable high-voltage may be the same, and the second component interface 258 may not involve any adaptation of the source voltage into the suitable high-voltage.

In some embodiments, the second component interface 258 may also include a power interface (not shown) which enables the second processing unit 134 to supply low-voltage power to different bathing unit components physically coupled to the second component interface 208 via a wired low-voltage power connection.

Accordingly, the second component interface 258 may allow the second processing unit 134 and certain bathing unit components to be directly and physically coupled via a wired connection, for (A) transmission of the low-speed communication signals as between the first processing unit 132 or the second processing unit 134 and the bathing unit components coupled to the second processing unit 134 and (B) distribution of high-voltage power or low-voltage power from the second processing unit 134 to the connected bathing unit components. The second component interface 258 may comprise any interface which enables the second processing unit 134 to perform the functions as described above and below, including specialized or standard interface technologies such as channel, port-mapped, asynchronous for example. For example, in the embodiment shown in FIGS. 4 and 5, the second component interface 258 includes: (A) a low-speed data/low-voltage power port 274 operable to receive the wired connection 213B for transmission of the low-speed communication signals and/or the low-voltage power directly between the first processing unit 132 and the bathing unit components coupled to the second processing unit 134; (B) a plurality of high-voltage power relays 276B, 276C and 276D operable to receive the respective wired power connections 215B, 215C and 215D for transmission of the high-voltage power from the second processing unit 134 to the connected bathing unit components; and (C) the combined high-voltage power/low-speed data interface 271 for allowing the heater 145 to be formed as an integral unit with the second processing unit 134. Those skilled in the art will appreciate that additional or alternative interfaces which allow the second component interface 258 to perform the functions as described above and below are possible, such as a combined data/power port operable for transmission of both the low-speed communication signals and the high-voltage power for example.

The low-speed data/low-voltage power ports 274 primarily allow data transfer via the low-speed communication signals between the first processing unit 132 (or the second processing unit 134) and the bathing unit components coupled to the second processing unit 134. The low-speed data/low-voltage power port 274 may also allow the first processing unit 132 to distribute low-voltage power to the bathing unit components coupled to the second processing unit 134. Correspondingly, the wired connection 213B coupling the low-speed data/low-voltage power port 274 to the connected bathing unit components also allow data transfer via the low-speed communication signals and optionally the distribution of low-voltage power from the first processing unit 132 (e.g., in embodiments where the first processing unit 132 is the master processing unit) or from the second processing unit 134 (e.g., in embodiments where the second processing unit 134 is the master processing unit). In the embodiment shown in FIGS. 4 and 5, the low-speed data/low-voltage power port 274 comprises a RS-485 port. In other embodiments, the low-speed data/low-voltage power port 274 may comprises the RS port (e.g., RS-485 ports, RS-232 ports, RS-422 ports), the I2C port, the older USB port (e.g., USB 1.0), etc.

In the embodiment shown in FIGS. 4 and 5, the low-speed data/low-voltage power ports 224 of the first processing unit 132), the low-speed data/low-voltage power ports 264 and 274 of the second processing unit 134, the low-speed data/low-voltage power ports 184A and 184B of the lighting driver 180, and the low-speed data/low-voltage power port 154 of the variable speed pump 150 enables a serial daisy-chain configuration for the low-speed data and low-voltage power connection between the first processing unit 132, the second processing unit 134, the lighting component 118 and the variable speed pump 150. More generally, the low-speed data/low-voltage power port 274 allows the second processing unit 134 to receive commands and updates from the first processing unit 132 and to allow the serially connected bathing unit components (e.g., the lighting component 118 and the variable speed pump 150 in the embodiment shown in FIG. 5) to also receive these commands and updates from the first processing unit 132. In one example, the commands and updates from the first processing unit 132 may be directly transmitted to the connected bathing unit components via the low-speed data/low-voltage power port 274 without any processing by the second processing unit 134; in other examples, the commands and updates from the first processing unit 132 may be processed or otherwise addressed by the second processing unit 134 before being passed on to the bathing unit components coupled to the second processing unit 134. Correspondingly, the low-speed data/low-voltage power port 264 also generally allows the second processing unit 134 to receive information from the connected bathing unit components and also allows the first processing unit 132 to receive this information for processing or storage thereof. Similar to the commands and updates described above, in some examples, the information from the bathing unit components coupled to the second processing unit 134 may be directly transferred to the first processing unit 132 via the low-speed data/low-voltage power port 264 without any processing by the second processing unit 134; in other examples, the information from the connected bathing unit components may be processed by the second processing unit 134 before being passed on to the first processing unit 132.

The plurality of high-voltage power relays 276B, 276C and 276D enables only power transfer between the second processing unit 134 and the connected bathing unit components. Correspondingly, the wired power connections 215B, 215C and 215D coupling the high-voltage power relays 276B, 276C and 276D to the bathing unit components also only allow power transfer. For some bathing unit components requiring a large amount of power for operation, only a single bathing unit component is coupled to a particular single high-voltage power relay 276. For example, referring to FIG. 5, the standard pump 151 is coupled to the single high-voltage power relay 276D and the variable speed pump 150 is coupled to the single high-voltage power relay 276C, as the motor of the pumps 151 and 150 may require a large amount of power to operate in the different modes as described above. Other bathing unit components may require a smaller amount of power for operation, and more than one of such bathing unit components may be simultaneously coupled to one particular high-voltage power relay 276. For example, still referring to FIG. 5, the audio driver 170 and the lighting driver 180 may all be coupled to a single high-voltage power relay 276B.

In some embodiments, a particular bathing unit component may be coupled to both a low-speed data/low-voltage power port 274 and a high-voltage power relay 276 of the second component interface 258. For example, referring to FIGS. 1 and 5, the lighting driver 180 includes both (A) the low-speed data port 184A which may be directly coupled to the low-speed data/low-voltage power port 274 of the second component interface 258 via the wired data connection 213B and (B) the high-voltage power interface 186 which may be directly coupled to the high-voltage power relay 276B of the second component interface 258 via the wired power connection 215B. As a further example, the variable speed pump 150 may include both: (A) the first low-speed data port 154 which may be ultimately serially coupled to the low-speed data/low-voltage power port 274 of the second component interface 258 via the lighting driver 180 and the wired data connections 213C and 213B and (B) the high-voltage power relay 256 which may be directly coupled to the high-voltage power relay 276C via the wired power connection 215C.

In other embodiments, the bathing unit component may only be coupled to a high-voltage power relay 276 of the second component interface 258. For example, still referring to FIGS. 1 and 5, the standard pump 151 may only include the high-voltage power relay 257, which may be directly coupled to the high-voltage power relay 276D of the second component interface 258 via the wired power connection 215D. As described above, the standard pump 151 may only have one speed and may only be responsive to an activation signal to turn on and off. For example, the standard pump 151 may only be responsive to second local processor 250 directing the second component interface 258 to provide or not provide the high-voltage power via the high-voltage power relay 276D. Similarly, the audio component 116 (i.e., the audio driver 170) may only include the high-voltage power interface 176 which may be directly coupled to the high-voltage power relay 276B of the second component interface 258 via the wired connection 215E in order to provide the audio component 116 with the high-voltage power. As described above, the audio data received and projected by the audio component 116 may require the high-speed communication signals directly from the first processing unit 132 for performance and fidelity, and utilizing the low-speed communication signals may cause undesirable lag and cause user dissatisfaction with the audio component 116 and/or the bathing unit system 100. Accordingly, the audio component 116 may not include any low-speed data ports for physically coupling with the first or second processing units 132 and 134, but may instead only include the high-speed data port 173 for physically coupling with the first processing unit 132.

The combined high-voltage power/low-speed data interface 271 may allow both data transfer via the low-speed communication signals and high-voltage power between the second processing unit 134 and the connected bathing unit component (in this case, specifically the heater 145). The combined high-voltage power/low-speed data interface 271 of the second component interface 258 with the combined high-voltage power/low-speed data interface 147 of the heater 145 may also specifically allow the heater 145 to be formed as an integral unit with the second processing unit 134. For example, the combined low-speed data/high-voltage power interface 147 may be at least one pin configured to fit into at least one recess formed by the corresponding combined high-voltage power/low-speed data interface 271.

Generally based on the examples above, those skilled in the art will recognize that the second component interface 258 allows the second processing unit 134 to be physically coupled to the different bathing unit components as follows:
(A) Bathing unit components which require high-voltage power may be (and are typically) directly and physically coupled to the second processing unit 134, irrespective of whether such bathing unit component require the high-speed communication signals or may utilize the low-speed communication signals. In this regard, in the embodiment shown, as between the first and second processing units 132 and 134, only the second processing unit 134 is capable of distributing high-voltage power.
(B) Bathing unit components which can use the low-voltage power may also be directly and physically coupled to the second processing unit 134, and may specifically be coupled to the second processing unit 134. In some embodiments, such bathing unit components may be ultimately coupled to the first processing unit 132 (via the second processing unit 134 and other bathing unit components) in a serial daisy-chain configuration, as the low-voltage power may be distributed by the first processing unit 132. In other embodiments, such a bathing unit component may be directly coupled to the second processing unit 134 which may distribute such low-voltage power separately from the first processing unit 132 and the serial daisy-chain configuration. In this regard, it may be more schematically efficient to couple certain bathing unit components which can utilize the low-voltage power to the second processing unit 134 in some embodiments.
(C) Bathing unit components which can utilize the low-speed communication signals may also be directly and physically coupled to the second processing unit 134, and may specifically be ultimately coupled to the first processing unit 132 via the second processing unit 134 and other bathing unit components in a serial daisy-chain configuration. In this regard, it may be more schematically efficient to couple certain bathing unit components which can utilize the low-speed communication signals to the second processing unit 134 using the daisy-chain configuration as only a single wired connection is required to connect to multiple bathing unit components.
(D) Bathing unit components which require the high-speed communication signals may also be directly and physically coupled to the second processing unit 134 if these bathing unit components also require the high-voltage power. However, such bathing unit components would also be directly and physically coupled to the first processing unit 132 as, in the embodiment shown, as between the first and second processing unit 132 and 134, only the first processing unit 132 is capable of communicating using the high-speed communication signals.

### Second Processor Interface 260

Similar to the first processor interface 210, the second processor interface 260 includes a communication interface for the second local processor 250 to communicate commands and software/firmware updates to, and receive information from, the first local processor 200 of the first processing unit 132. For example, commands and updates received by the first processing unit 132 (e.g., user inputs and software/firmware updates received via the first network interface 206 from the user device 136 and/or the control server 131 or via the first component interface 208 from the topside control panel 138) may be transferred or relayed to the second processing unit 134 over the first processor interface 210 and then the second processor interface 260. In the embodiment shown in FIGS. 1 and 5, the second processor interface 260 allows communication between first and second local processors 200 and 250 via a wired low-speed data connection. However, in other embodiments, the second processor interface 260, alone or in combination with the second component interface 258, may comprise ports or other interfaces which allow the second local processor 250 to communicate with the first local processor 200 via the wireless network 220 (e.g., an inductive network, the Wi-Fi network, the Bluetooth network, or the cellular network).

The second processor interface 260 may also include a power interface for the first processing unit 132 to distribute low-voltage power to the second set bathing unit components coupled to the second processing unit 134. In the embodiment shown in FIG. 1 and 5, the second processor interface 260 allows the first processing unit 132 to transfer low-voltage power over a wired combined low-speed data/low-voltage power connection.

The second processor interface 260 may also include a power interface for transmitting the high-voltage power from the power source 140 to the first processing unit 132. In the embodiment shown in FIGS. 1 and 5, the second processor interface 260 allows the transfer of the high-voltage power between the first and second processing units 132 and 134 using a wired high-voltage power connection. However, in other embodiments, the second processor interface 260, alone or in combination with the second component interface 258, may comprise ports or other interfaces which allow the second processing unit 134 to transfer the high-voltage power to the first processing unit 132 via the wireless network 220 (e.g., an inductive network).

Accordingly, the second processor interface 260 may allow the first processing unit 132 and the second processing unit 134 to be directly and physically coupled via a wired connection, for (A) transmission of the low-speed communication signals as between the first and second processing units 132 and 134, (B) distribution of the low-voltage power from the first processing unit 132 to the second set bathing unit components coupled to the second processing unit 134 and (C) distribution of high-voltage power from the second processing unit 134 to the first processing unit 132. The second processor interface 260 may comprise any interface which enables the second processing unit 134 to perform the functions as described above and below, including specialized or standard interface technologies such as channel, port-mapped, asynchronous for example. In the embodiment shown in FIGS. 4 and 5, the second processor interface 260 includes: (A) the low-speed data/low-voltage power port 264 operable to receive the wired connection 213A for transmission of the low-speed communication signals and, optionally, distribution of the low-voltage power, both from the first processing unit 132; and (B) one or more high-voltage power relays 266 operable to receive the wired power connection 215A for transmission of the high-voltage power to the first processing unit 132. Those skilled in the art will appreciate that additional or alternative interfaces which allow the second processor interface 260 to perform the functions as described above and below are possible, such as a combined data/power port operable for transmission of both the low-speed communication signals and the high-voltage power for example.

The low-speed data/low-voltage power port 264 allows data transfer via the low-speed communication signals between the second processing unit 134 and the connected first processing unit 132, as well as between the first processing unit 132 and the second set bathing unit components coupled to the second processing unit 134. The low-speed data/low-voltage power port 264 may also allow the first processing unit 132 to distribute low-voltage power to the second set bathing unit components coupled to the second processing unit 134. Correspondingly, the wired connection 213A coupling the low-speed data/low-voltage power port 264 to the first processing unit 132 (via the low-speed data/low-voltage power port 224 of the first processor interface 210) also allows data transfer via the low-speed communication signals and power transfer via the low-voltage power. In the embodiment shown in FIGS. 4 and 5 the low-speed data/low-voltage power port 264 comprises a RS-485 port similar to the low-speed data/low-voltage power port 224 of the first processor interface 210 and the low-speed data/low-voltage power port 274 of the second component interface 258. In other embodiments, the low-speed data/low-voltage power port 264 comprises the RS port (e.g., RS-485 ports, RS-232 ports, RS-422 ports), the I2C port, the older USB port (e.g., USB 1.0), etc. The low-speed data/low-voltage power port 264 generally allows the second processing unit 134 to receive commands (e.g., via the control panel 138, the user device 138 or the control server 131) and software/firmware updates (e.g., via the user device 138 or the control server 131) from the first processing unit 132 and for the first processing unit 132 to transmit these commands and updates directly to the second set bathing unit components coupled to the second processing unit 134 as described above. In one example, the commands and updates from the first processing unit 132 may be directly and serially transmitted to the connected bathing unit components via the low-speed data/low-voltage power port 264 without any processing by the second processing unit 134; in other examples, the commands and updates from the first processing unit 132 may be processed or otherwise addressed by the second processing unit 134 before being passed on to the connected bathing unit components. The low-speed data/low-voltage power port 264 also generally allows information initially received from the second set bathing unit component to be transmitted to the first processing unit 132. Similar to commands and updates described above, in some examples, the data from the connected bathing unit components may be directly transferred to the first processing unit 132 via the low-speed data/low-voltage power port 264 without any processing by the second processing unit 134; in other examples, the data from the connected bathing unit components may be processed by the second processing unit 134 before being passed on to the first processing unit 132. The low-speed data/low-voltage power port 264 also allows the first processing unit 132 to distribute low-voltage power to the second set bathing unit components coupled to the second processing unit 134.

The one or more high-voltage power relay 266 allows only power transfer between the second processing unit 134 and the connected first processing unit 132. Correspondingly, the wired power connection 215A coupling the high-voltage power relay 276 to the first processing unit 132 (e.g., via the high-voltage power port 226 of the first processor interface 210) also allows only power transfer between the first and second processing units 132 and 134. The high-voltage power relay 276 generally allows the second processing unit 134 to distribute the high-voltage power from the power source 140 to the first processing unit 132.

### Control Server 131

Referring back to FIGS. 1 and 5, the control server 131 may include (a) a control processor for performing the operations of the control server 131 (e.g., by executing instructions stored in a program memory of the control server 131); (b) the program memory configured to store instructions which may be executed in order to implement various functionality of the control server 131; (c) a storage memory configured to store data in order to implement various functionality of the control server 131; and (d) a network interface (e.g., a transmitter/receiver with an antenna or a network interface card or a port) for communicating with the control system 130, the user device 136, and/or the external systems associated with external service providers or a manufacturer of the bathing unit system 100 (or of specific bathing unit components) over the wireless network 220. In other embodiments, the control server 131 may also include ports/interfaces which allow the control processor to communicate with the control system 130, the user device 136 and/or the external systems via wired connections.

For example, as described above, in some embodiments, a manufacturer of the bathing unit system 100 (or of specific bathing unit components) may upload certain software or firmware updates to the control server 131. The control server 131 may push these updates over the wireless network 220 to the control systems 130 of a plurality of different bathing unit systems 100, based on the configuration and the bathing unit components associated with the bathing unit systems 100 and whether the updates are relevant for those configurations and bathing unit components. As also described above, in some embodiments, commands for controlling a particular bathing unit system 100 may initially be received at the control server 131. For example, user input received via a particular user device 136 may initially be transferred to the control server 131. The control server 131 may then push these commands over the wireless network 220 to the control system 130 of a relevant bathing unit system 100.

In the embodiment shown, only the first processing unit 132 is capable of communicating with the control server 131 over the wireless network 220. As described above, the second processing unit 134 may not communicate with the control server 131 as the second processing unit 134 may not include a network interface. In this regard, referring to FIGS. 3 and 5, the first processing unit 132 includes the first network interface 206 forming a communication interface with the control server 131. The first processing unit 132 then relays the commands and updates received from the control server 131 to the second processing unit 134 (via the first processor interface 210 and the second processor interface 260 as described above) and to the bathing unit components coupled to either the first or the second processing units 132 and 134. The first processing unit 132 may also control, based on the commands received from the control server 131, the bathing unit components coupled to either the first or the second processing units 132 and 134. Correspondingly, the first processing unit 132 also transmits information from the second processing unit 134, or from the bathing unit components coupled to either the first or the second processing units 132 and 134, to the control server 131 in the opposite direction. However, in other embodiments, the second processing unit 134 may include a network interface to communicate with the control server 131 over the wireless network 220.

### Topside Control Panel 138

Referring to FIGS. 1, 2 and 5, the topside control panel 138 may include: (a) a panel processor for performing the operations of the topside control panel 138 (e.g., by executing instructions stored in a program memory of the topside control panel 138); (b) the program memory configured to store instructions which may be executed in order to implement various functionality of the topside control panel 138, including user interface codes which cause different pages, menus and notification messages to be displayed on the user interface of the topside control panel 138; (c) a storage memory configured to store data in order to implement various functionality of the topside control panel 138; (d) a communication interface (e.g., a transmitter/receiver with an antenna or a interface/port) for communicating with the control system 130, the control server 131, the external system, and the user device 136 if and as applicable; and (c) a user interface (e.g., keypad, the display screen, touchscreen, rotary input device) for receiving user input interacting with, and for displaying information regarding the bathing unit system 100, including via the different pages, menus and notification messages. The communication interface generally allows the topside control panel 138 to transmit commands to, and receive information from, the control system 130 over a wired connection. Examples of a topside control panel include various embodiments described in the related U.S. application Ser. No. 17/515,703, entitled “TOPSIDE CONTROL PANEL AND TOPSIDE CONTROL PANEL SYSTEM FOR BATHING UNIT SYSTEM AND METHOD OF OPERATING THE SAME”, filed on Nov. 1, 2021 and related U.S. Pat. No. 10,353,499, entitled “TOPSIDE CONTROL PANEL FOR BATHING UNIT SYSTEM”, filed on Mar. 19, 2018, the contents of which are incorporated by reference herein. However, in other embodiments, the communication interface may allow the topside control panel 138 to communicate commands to the control system 130 over the wireless network 220.

For example, as described above, in certain embodiments, the user interface of the topside control panel 138 may allow a user to interact with menus to provide user input for controlling various bathing unit components of the bathing unit system 100. For example, a user can interact with the topside control panel 138 to provide user input which change a desired temperature of the water 103 within the receptacle 102 implemented using the heater 145, change ambience settings implemented using the lighting component 118 and/or the audio component 116, and change jet settings implemented using the variable speed pump 150 or the standard pump 151. The topside control panel 138 may then provide this user input to the control system 130 over the wired data/power connection 211A.

In the embodiment shown, only the first processing unit 132 is operable to communicate with the topside control panel 138 over the wired data/power connection 211A. As described above, the second processing unit 134 may not directly communicate with the topside control panel 138, in order to isolate more complex processing functions in the first processing unit 132. In this regard, referring to FIGS. 3 and 5, the first processing unit 132 includes the first component interface 208 forming both a communication interface and a power interface with the topside control panel 138. In particular, the first component interface 208 includes the high-speed data/low-voltage power port 212A operable to receive the wired data/power connection 211A for physically coupling the first processing unit 132 with the topside control panel 138. The first processing unit 132 then relays the commands from the topside control panel 138 to the second processing unit 134 (via the first processor interface 210 in the second processor interface 260 as described above) and to the bathing unit components coupled to either the first or the second processing units 132 and 134. The first processing unit 132 may also control, based on the commands received from the topside control panel 138, the bathing unit components coupled to either the first or the second processing units 132 and 134. Correspondingly, the first processing unit 132 also transmits information from the second processing unit 134, or from the bathing unit components coupled to either the first or the second processing units 132 and 134, back to the topside control panel 138 in the opposite direction. However, in other embodiments, the second component interface 258 may include one or more ports/interfaces which allow the second processing unit 134 to directly communicate with the topside control panel 138 over a wired connection.

### User Device 136

Referring to FIGS. 1 and 5, the user device 136 may be any communication device which can be associated with a user of the bathing unit system 100. The user device 136 may comprise, for example, a mobile phone, or a tablet, or a laptop, or a personal computer, a smart watch, a wearable device etc., associated with the corresponding user.

The user device 136 may include: (a) a device processor for performing the operations of the user device 136 (e.g., by executing instructions stored in a program memory thereof); (b) the program memory configured to store instructions which may be executed in order to implement various functionality of the user device 136; (c) a storage memory configured to store data in order to implement various functionality of the user device 136; (d) a communication interface (e.g., a transmitter/receiver with an antenna or an interface card or a port) for communicating with the control system 130, the control server 131, the external system, and/or the topside control panel 138 if and as applicable; and (e) the user interface (e.g., keyboard, the display screen, and/or touchscreen) for receiving user input and for displaying information regarding the bathing unit system 100, including via the different pages, menus and notification messages.

In some embodiments, the user device 136 may comprise an external system separate from the bathing unit system 100 and may store or enable retrieval of the external data. For example, the external data may be retrieved from software applications stored on the program and storage memories of the user device 136 and executed by the device processor of the user device 136. For example, the external data may include one or more of: (i) the weather condition data and/or the ambient temperature data which may be retrieved from the weather application installed on the user device 136; (ii) the energy cost data which may be retrieved from an energy management application installed on the user device 136; and (iii) the user location data which may be retrieved at least in part based on data from a position receiver on the user device 136.

In some embodiments, the user device 136 may include a bathing unit system control application installed thereon, which may facilitate transmission commands to, and receipt of information from, the control system 130 and/or directly to the bathing unit components over the wireless network. For example, a user can interact with the GUI of the control application to provide user input which change a desired temperature of the water 103 within the receptacle 102 implemented using the heater 145, change ambience settings implemented using the lighting component 118 and/or the audio component 116, change jet settings implemented using the variable speed pump 150 or the standard pump 151, etc. The user device 136 may then transmit this user input to the control system 130 (potentially via the control server 131 and/or the topside control panel 138) over the wireless network 220. As an additional example, a user may interact with the user interface of the user device 136 to cause the user device 136 to transmit audio data or audiovisual data to the control system 130 to cause the audio component 116 and/or the visual display 120 to play the audio data or the audiovisual data.

In the embodiment shown, only the first processing unit 132 is capable of communicating with the user device 136 over the wireless network 220. As described above, the second processing unit 134 may not communicate with the user device 136 as the second processing unit 134 may not include a network interface. In this regard, referring to FIGS. 3 and 5, the first processing unit 132 includes the first network interface 206 forming the communication interface with the user device 136. The first processing unit 132 then relays the commands and updates received from the user device 136 to the second processing unit 134 (via the first processor interface 210 and the second processor interface 260 as described above) and to the bathing unit components coupled to either the first or the second processing units 132 and 134. The first processing unit 132 may also control, based on the commands received from the user device 136, the bathing unit components coupled to either the first or the second processing units 132 and 134. Correspondingly, the first processing unit 132 also relays information from the second processing unit 134, or from the bathing unit components coupled to either the first or the second processing units 132 and 134, back to the user device 136 in the opposite direction. However, in other embodiments, the second processing unit 134 may include a network interface to communicate with the user device 136 over the wireless network 220.

### Configuration of First Processing Unit 132 and Second Processing Unit 134

The first processing unit 132 and the second processing unit 134 allow the bathing unit system 100 to be configured in a manner which allows coupling of additional bathing unit components to the control system 130 while maintaining the enhanced connectivity of the control system 130 and aesthetics of the bathing unit system 100.

In this regard, as described above, both the first processing unit 132 and the second processing unit 134 are positioned within the spa cabinet 105 of the bathing unit system 100. This generally allows both the first processing unit 132 and the second processing unit 134 to be positioned at a location which is more convenient to connect the different bathing unit components (e.g., the high-voltage elements) to the second processing unit 134 and the low-voltage elements of bathing unit components to either the first processing unit 132 or the second processing unit 134. In this regard, in a typical configuration of the bathing unit system 100, many of the bathing unit components are also positioned within the spa cabinet 105. Positioning both the first processing unit 132 and the second processing unit 134 within the same spa cabinet 105 may allow easier connectivity of the first and second processing units 132 and 134 to the respective bathing unit components; this positioning may also allow the final bathing unit system 100 to be more aesthetically pleasing, as no unsightly cables or connection are exposed.

The first component interface 208 allows the low-voltage bathing unit components or the low-voltage elements (e.g., communication elements, processing elements, or sensing elements) of the bathing unit components to be physically coupled to the first processing unit 132. As described above, the first processing unit 132 is configured to supply the low-voltage power via the first component interface 208. The second component interface 258 allows the high-voltage bathing unit components or the high-voltage elements (a.k.a. active elements) of some of the bathing unit components to be physically coupled to the second processing unit 134. The second component interface 258 may also allow the low-voltage bathing unit components or the low-voltage elements of some of the bathing unit components to be physically coupled to the second processing unit 134. The second processing unit 134 is configured to supply both the low-voltage power (either directly from the second processing unit 134 or relayed from the first processing unit 132) and the high-voltage power via the second component interface 258. This isolation of the source of the high-voltage power in the second processing unit 134 can reduce an amount of heat natively generated within each of the first and second processing units 132 and 134.

Additionally, the second processing unit 134 may generate more heat than the first processing unit 132 due to the high-voltage supplied by the second processing unit 134 to high-voltage elements. Placing additional processing functionality into the first processing unit 132 (e.g., supplying the low-voltage) rather than the second processing unit 134 (e.g., supplying the high-voltage) may distribute heat production more evenly as between the first and the second processing units 132 and 134. For example, using the second processing unit 134 to distribute the high-voltage power may shield the processing capabilities of the first processing unit 132 from heat which may be generated from such power distribution. Additionally, only including the first network interface 206 in the first processing unit 132 also shield this first network interface 206 from heat that may be generated from such power distribution.

The combination of the first network interface 206, the first processor interface 210, the second processor interface 260 and the second component interface 258 allow the first processing unit 132 to transmit commands and updates to the second set bathing unit components coupled to the second processing unit 134. More specifically, the above combination of interfaces allow: (a) the first processing unit 132 to receive second set commands for controlling high-voltage elements of bathing unit components from the topside control panel 138, the user device 136 or the control server 131 (via the first network interface 206); (b) the first processing unit 132 to then transmit the second set commands to the second processing unit 134 and/or directly to the low-voltage elements of the bathing unit component via the communication interfaces of the first and second processor interfaces 210 and 260 and the second component interface 258; and (c) the second processing unit 134 to then control power distribution to the high-voltage bathing unit components or the high-voltage element of the bathing unit components via the power interfaces of the second component interface 258. Similarly, the above combination of interfaces also generally allow: (a) the first processing unit 132 to receive second set updates for updating high-voltage bathing unit components from the control server 131, the user device 136 or the topside control panel 138 (again via the first network interface 206); (b) the first processing unit 132 to relay the second set updates to the high-voltage bathing unit component via the communication interfaces of the second component interface 258.

In contrast, the combination of the first network interface 206 and the first component interface 208 allows the first processing unit 132 to transmit commands and updates directly to the low-voltage bathing unit components or to the low-voltage elements (e.g., processing elements, sensing elements, communications elements) of the bathing unit components which are coupled to the first processing unit 132. More specifically, the above combination of interfaces allows the first processing unit 132 to both: (a) receive first set commands for controlling low-voltage elements of bathing unit components from the control server 131, the user device 136 or the topside control panel 138 (via the first network interface 206); and (b) then transmit the first set commands directly to low-voltage bathing unit components or to the low-voltage elements via the communication interfaces of the first component interface 208. Similarly, the above combination of interfaces also generally allows the first processing unit 132 to both: (a) receive first set updates for updating the low-voltage bathing unit components from the control server 131, the user device 136 or the topside control panel 138 (again via the first network interface 206); and (b) then transmit the first set updates directly to the low-voltage bathing unit components or to the low-voltage elements via the communication interfaces of the first component interface.

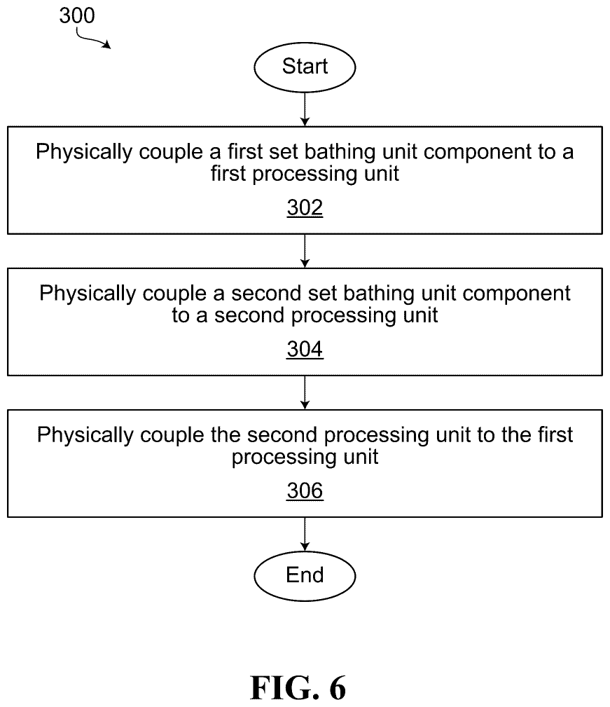

Referring now to FIG. 6, a method for controlling operation of the bathing unit system comprising the plurality of bathing unit components, when the bathing unit components comprises a first set bathing unit components and a second set bathing unit component is shown generally at 300.

The method starts at block 302 which comprises physically coupling the first set bathing unit component to the first processing unit 132. As described above, the first processing unit 132 may be located within the spa cabinet 105. For example, in some embodiments, referring to FIG. 5, block 302 may involve physically coupling the topside control panel 138 to the first component interface 208 of the first processing unit 132 with the wired data/power connection 211A. More specifically, the wired data/power connection 211A may physically couple the topside control panel 138 and the high-speed data/low-voltage power port 212A of the first component interface 208. Additionally or alternatively, and still referring to FIG. 5, block 302 may also involve physically coupling the audio driver 170 to the first component interface 208 via the wired data/power connection 211B. More specifically, the wired data/power connection 211B may physically couple the high-speed data port 173 of the audio driver 170 and the high-speed data/low-voltage power port 212B of the first component interface 208.

The method then continues to block 304, which comprises physically coupling the second set bathing unit component to the second processing unit 134. As described above, the second processing unit 134 may be physically distinct from the first processing unit 132. For example, in some embodiments, being “physically distinct” means that the first and second processing units 132 and 134 comprise two separate and distinct enclosed bodies 201 and 251. As also described above, the second processing unit 134 may also be located within the spa cabinet 105. The separate and distinct enclosed bodies 201 and 251 of the first and second processing units 132 and 134 may physically contact each other or may otherwise be adjacent or proximate each other in the spa cabinet 105.

In some embodiments and referring to FIG. 5, block 304 may involve physically coupling the lighting driver 180 to the second component interface 258 of the second processing unit 134 via the wired power connection 215B and the wired data connection 213B. More specifically, the wired power connection 215B may physically couple the high-voltage power interface 186 of the lighting driver 180 with the high-voltage really 276B of the second component interface 258, whereas the wired power connection 213B may physically couple the low-speed data port 184A of the lighting driver 180 with the low-speed data/low-voltage power port 274 of the second component interface 258. Additionally or alternatively, and still referring to FIG. 5, block 304 may involve physically coupling the variable speed pump 150 to the second component interface 258 via the wired power connection 215C and the wired data connection 213C (e.g., serially in a daisy-chain configuration). More specifically, the wired power connection 215C may physically couple the high-voltage power relay 256 of the variable speed pump 150 and the high-voltage power relay 276C of the second component interface 258, whereas the wired data connection 213C may physically couple the low-speed data port 154 of the variable speed pump 150 with the low-speed data port 184B of the lighting driver 180 to daisy chain to the low-speed data/low-voltage power port 274 of the second component interface 258.

Additionally or alternatively, and still referring to FIG. 5, block 304 may involve physically coupling the standard pump 151 to the second component interface 258 via the wired power connection 215D only. More specifically, the wired power connection 215D may physically couple the high-voltage power relay 257 of the standard pump 151 with the high-voltage power relay 276D of the second component interface 258. Similarly, and still referring to FIG. 5, block 304 may also involve physically coupling the audio driver 170 to the second component interface 258 via the wired power connection 215E only. More specifically, the wired power connection 215E may physically couple the high-voltage power interface 176 of the audio driver 170 with the high-voltage power relay 276B of the second component interface 258.

As a further embodiment, and still referring to FIG. 5, block 304 may also involve integrating the heater 145 with the second processing unit 134 via the combined power/data interface 219 and into an integrated unit. In this regard, the combined high-voltage power and low-speed data interface 147 of the heater 145 may be slotted into, received in, receive, or otherwise interface with the corresponding combined high-voltage power and low-speed data interface 271 of the second component interface 258 to transfer both the high-voltage power and the low-speed communication signals.

The method then continues to block 306, which comprises physically coupling the first processing unit 132 and the second processing unit 134. For example, in some embodiments and referring to FIG. 5, block 306 may involve physically coupling the first processing unit 132 to the second processing unit 134 via the wired data connection 213A and the wired power connection 215A. More specifically, the wired power connection 215A may physically couple the high-voltage power port 226 of the first processor interface 210 within the high-voltage power relay 266 of the second processor interface 260, whereas the wired data connection 213A may instead physically couple the low-speed data/low-voltage power port 224 of the first processor interface 210 with the low-speed data/low-voltage power port 264 of the second processor interface 260. The method 300 may then end.

### Conclusion

The person skill in the art will appreciate that many variations to the embodiments described in the present document art possible and will become apparent from a reading of the present document concurrently with the figures.

It will be understood by those of skill in the art that throughout the present specification, the term “a” used before a term encompasses embodiments containing one or more to what the term refers. It will also be understood by those of skill in the art that throughout the present specification, the term “comprising”, which is synonymous with “including,” “containing,” or “characterized by,” is inclusive or open-ended and does not exclude additional, un-recited elements or method steps. Unless otherwise defined, all technical and scientific terms used herein have the same meaning as commonly understood by one of ordinary skill in the art to which this invention pertains. In the case of conflict, the present document, including definitions will control.

As used in the present disclosure, the terms “around”, “about”, “substantially” or “approximately” shall generally mean within the error margin generally accepted in the art. Hence, numerical quantities given herein generally include such error margin such that the terms “around”, “about” “substantially” or “approximately” can be inferred if not expressly stated. For greater clarity, unless otherwise explicitly stated, the terms “around”, “about”, “substantially” and “approximately” means a proportion of at least about 60%, or at least about 70% or at least about 80%, or at least about 90%, at least about 95%, at least about 97% or at least about 99% or more, or any integer between 70% and 100%.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

Although various embodiments of the invention have been described and illustrated, it will be apparent to those skilled in the art in light of the present description that numerous modifications and variations can be made. The scope of the invention is defined more particularly in the appended claims.

1. A method for controlling operation of a bathing unit system comprising a plurality of bathing unit components, the plurality of bathing unit components comprising a first set bathing unit component and a second set bathing unit component different from the first set bathing unit component, the method comprising:
physically coupling the first set bathing unit component to a first processing unit located within a spa cabinet of the bathing unit system;
physically coupling the second set bathing unit component to a second processing unit physically distinct from the first processing unit and located within the spa cabinet; and
physically coupling the second processing unit to the first processing unit,
wherein the first processing unit is configured to:
receive second set commands for controlling the second set bathing unit component from at least one control device of the bathing unit system; and
relay the second set commands to the second set bathing unit component via the second processing unit, and
wherein the second processing unit is configured to supply power to the second set bathing unit component.

2. The method of claim 1, wherein the first processing unit is further configured to supply power to the first set bathing unit component.

3. The method of claim 2, wherein the power supplied by the first processing unit to the first set bathing unit component comprises power at a low-voltage level and the power supplied by the second processing unit to the second set bathing unit component comprises power at a high-voltage level.

4. The method of claim 3, wherein the low-voltage level is at most 5V, at most 12V, or at most 50V.

5. The method of claim 4, wherein the high-voltage level is at least 120V, at least 230V or at least 240V.

6. The method of claim 3, wherein the first processing unit is not operable to supply the power at the high-voltage level.

7. The method of claim 1, wherein the first processing unit is further configured to:
receive first set commands from the at least one control device for controlling the first set bathing unit component; and
transmit the first set commands to directly to the first set bathing unit component.

8. The method of claim 7, wherein the first processing unit includes at least one interface configured to wirelessly receive the second set commands and the first set commands from the at least one control device.

9. The method of claim 8, wherein the at least one interface comprises one or more of: a Bluetooth interface, a Wi-Fi interface, a cellular interface and another wireless network interface.

10. The method of claim 1, wherein:
the second set bathing unit component is one of a plurality of second set bathing unit components, each bathing unit component in the plurality of second set bathing unit components being physically coupled to the second processing unit; and
the first set bathing unit component is one of a plurality of first set bathing unit components, each bathing unit component in the plurality of first set bathing unit components being physically coupled to the first processing unit.

11. The method of claim 10, wherein the plurality of second set bathing unit components comprises one or more of: a temperature change component, a pump, a lighting component, an air blower and an audio component.

12. The method of claim 10, wherein the plurality of first set bathing unit components comprise one or more of: a lighting component, an audio component, a sanitizer component, a visual display, a topside control panel, and a sensor.

13. The method of claim 10, wherein the first processing unit is further configured to:
automatically derive identification information for specific bathing unit components within the plurality of first set bathing unit components; and
automatically adjust how each bathing unit component in the plurality of first set bathing unit components is controlled at least in part based on the derived identification information.

14. The method of claim 1, wherein the first processing unit is further configured to:
receive second set updates for updating the second set bathing unit component from the at least one control device; and
transmit the second set updates to the second set bathing unit component.

15. The method of claim 1, wherein the first processing unit is further configured to:
receive first set updates for updating the first set bathing unit component from the at least one control device; and
transmit the first set updates directly to the first set bathing unit component.

16. The method of claim 1, wherein the at least one control device comprises one or more of: a topside control panel, a GUI displayed on a personal user device associated with a user, and a control server.

17. A bathing unit system comprising:
a plurality of bathing unit components comprising a first set bathing unit component and a second set bathing unit component different from the first set bathing unit component;
a first processing unit located within a spa cabinet of the bathing unit system and physically coupled to the first set bathing unit component; and
a second processing unit located within the spa cabinet, physically coupled to and physically distinct from the first processing unit, and physically coupled to the second set bathing unit component,
wherein the first processing unit is configured to:
receive second set commands for controlling the second set bathing unit component from at least one control device of the bathing unit system; and
transmit the second set commands to the second set bathing unit component, and
wherein the second processing unit is configured to supply power to the second set bathing unit component.

18. The bathing unit system of claim 17, wherein the first processing unit is further configured to supply power to the first set bathing unit component.

19. The bathing unit system of claim 18, wherein power supplied by the first processing unit to the first set bathing unit component comprises power at a low-voltage level and the power supplied by the second processing unit to the second set bathing unit component comprises power at a high-voltage level.

20. The bathing unit system of claim 19, wherein the first processing unit is not operable to supply the power at the high-voltage level.

21. The bathing unit system of claim 17, wherein the first processing unit is further configured to:
receive first set commands from the at least one control device for controlling the first set bathing unit component; and
transmit the first set commands directly to the first set bathing unit component.

22. The bathing unit system of claim 21, wherein the first processing unit includes at least one interface configured to wirelessly receive the second set commands and the first set commands from the at least one control device.

23. The bathing unit system of claim 17, wherein the second set bathing unit component is part of a plurality of second set bathing unit components and wherein the first set bathing unit component is part of a plurality of first set bathing unit components, wherein the bathing unit system further comprises:
the plurality of second set bathing unit components, each bathing unit component in the plurality of second set bathing unit components being physically coupled to the second processing unit; and
the plurality of first set bathing unit components, each bathing unit component in the plurality of first set bathing unit components being physically coupled to the first processing unit.

24. The bathing unit system of claim 23, wherein the plurality of second set bathing unit components comprise one or more of: a temperature change component, a pump, an air blower, a lighting component, and an audio component.

25. The bathing unit system of claim 23, wherein the plurality of first set bathing unit components comprise one or more of: a lighting component, an audio component, an sanitizer component, a visual display, a topside control panel, and a sensor.

26. The bathing unit system of claim 17, wherein the first processing unit is further configured to:
receive second set updates for updating the second set bathing unit component from the at least one control device; and
transmit the second set updates to the second set bathing unit component.

27. The bathing unit system of claim 17, wherein the first processing unit is further configured to:
receive first set updates for updating the first set bathing unit component from the at least one control device; and
transmit the first set updates directly to the first set bathing unit component.

28. A method for controlling operation of a bathing unit system comprising a specific bathing unit component having at least one high-voltage element and at least one low-voltage element, the method comprising:
physically coupling a communication interface of the specific bathing unit component to a first processing unit located within a spa cabinet of the bathing unit system, the communication interface being coupled to the at least one low-voltage element of the specific bathing unit component;
physically coupling a power interface of the specific bathing unit component to a second processing unit located within the spa cabinet, the power interface being coupled to the at least one high-voltage element of the specific bathing unit component; and
physically coupling the second processing unit to the first processing unit, and
wherein the first processing unit is configured to directly transmit communication signals to the at least one low-voltage element of the specific bathing unit component via the communication interface, and
wherein the second processing unit is configured to supply power to the at least one high-voltage element of the specific bathing unit component via the power interface.

29. The method of claim 28, wherein the specific bathing unit component is one or more of: a temperature change component, a pump, an air blower, a lighting component, an audio component, a visual display, and a sensor.

30. The method of claim 29, wherein the first processing unit is further configured to supply power to the at least one low-voltage element of the specific bathing unit component.

31. The method of claim 30, wherein the power supplied by the first processing unit to the at least one low-voltage element of the specific bathing unit component comprises power at a low-voltage level and wherein the power supplied by the second processing unit to the at least one high-voltage element of the specific bathing unit component comprises power at a high-voltage level, wherein the low-voltage level is at most 50V and the high-voltage level is at least 120V.

32. The method of claim 28, further comprising physically coupling at least one second set bathing unit component to the second processing unit, wherein the first processing unit is further configured to:
receive commands for controlling the at least one second set bathing unit component from at least one control device of the bathing unit system; and
transmit the commands to the at least one second set bathing unit component.

33. A bathing unit system comprising:
a specific bathing unit component having at least one high-voltage element and at least one low-voltage element, the specific bathing unit component having:
a communication interface coupled to the at least one low-voltage element of the specific bathing unit component; and
a power interface coupled to the at least one high-voltage element of the specific bathing unit component;
a first processing unit located within a spa cabinet of the bathing unit system and physically coupled to the communication interface of the specific bathing unit component; and
a second processing unit located within the spa cabinet, physically coupled to and physically distinct from the first processing unit, and physically coupled to the power interface of the specific bathing unit component,
wherein the first processing unit is configured to directly transmit communication signals to the at least one low-voltage element of the specific bathing unit component via the communication interface; and
wherein the second processing unit is configured to supply power to the at least one high-voltage element of the specific bathing unit component via the power interface.
